(19) United States
(12) Patent Application Publication
(10) Pub. No.: US 2008/0021854 A1
(43) Pub. Date: Jan. 24, 2008

(54) Search techniques related to tissue coding

(75) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US); Lowell L. Wood JR., Livermore, CA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/586,349

(22) Filed: Oct. 24, 2006

Related U.S. Application Data
(63) Continuation-in-part of application No. 11/362,545, filed on Feb. 24, 2006.

(51) Int. Cl. G06N 5/00

(52) U.S. Cl. 706/45

(57) ABSTRACT

An apparatus, device, methods, computer program product, and system are described that receive a request for a treatment option, the request associated with at least one query parameter, determine at least one treatment parameter, based on the request, the at least one treatment parameter including at least one target-related tissue ancestry-correlated binding site and/or at least one target-related tissue ancestry-correlated binding agent, and provide the treatment option, based on the at least one treatment parameter and the at least one query parameter.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

1. For purposes of the USPTO extra-statutory requirements, the present application constitutes a continuation in part of currently co-pending U.S. patent application entitled Data Techniques Related to Tissue Coding, naming Edward K. Y. Jung, Robert W. Lord, and Lowell L. Wood, Jr., as inventors, U.S. Ser. No. 11/222,031, filed Sep. 8, 2005.
2. For purposes of the USPTO extra-statutory requirements, the present application constitutes a continuation in part of currently co-pending U.S. patent application entitled Data Techniques Related to Tissue Coding, naming Edward K. Y. Jung, Robert W. Lord, and Lowell L. Wood, Jr., as inventors, U.S. Ser. No. 11/241,868, filed Sep. 30, 2005.
3. For purposes of the USPTO extra-statutory requirements, the present application constitutes a continuation in part of currently co-pending U.S. patent application entitled Accessing Data Related to Tissue Coding, naming Edward K. Y. Jung, Robert W. Lord, and Lowell L. Wood, Jr., as inventors, U.S. Ser. No. 11/262,499, filed Oct. 28, 2005.
4. For purposes of the USPTO extra-statutory requirements, the present application constitutes a continuation in part of currently co-pending U.S. patent application entitled Accessing Data Related to Tissue Coding, naming Edward K. Y. Jung, Robert W. Lord, and Lowell L. Wood, Jr., as inventors, U.S. Ser. No. 11/286,133, filed Nov. 23, 2005.
5. For purposes of the USPTO extra-statutory requirements, the present application constitutes a continuation in part of currently co-pending U.S. patent application entitled Accessing Predictive Data, naming Edward K. Y. Jung, Royce A. Levien, Robert W. Lord, Mark A. Malamud, John D. Rinaldo Jr., and Lowell L. Wood, Jr., as inventors, U.S. Ser. No. 11/311,906, filed Dec. 19, 2005.
6. For purposes of the USPTO extra-statutory requirements, the present application constitutes a continuation in part of currently co-pending U.S. patent application entitled Accessing Predictive Data, naming Edward K. Y. Jung, Royce A. Levien, Robert W. Lord, Mark A. Malamud, John D. Rinaldo Jr., and Lowell L. Wood, Jr., as inventors, U.S. Ser. No. 11/314,730, filed Dec. 21, 2005.
7. For purposes of the USPTO extra-statutory requirements, the present application constitutes a continuation in part of currently co-pending U.S. patent application entitled Accessing Predictive Data, naming Edward K. Y. Jung, Royce A. Levien, Robert W. Lord, Mark A. Malamud, John D. Rinaldo Jr., and Lowell L. Wood, Jr., as inventors, U.S. Ser. No. 11/343,965, filed Jan. 31, 2006.
8. For purposes of the USPTO extra-statutory requirements, the present application constitutes a continuation in part of currently co-pending U.S. patent application entitled Filtering Predictive Data, naming Edward K. Y. Jung, Royce A. Levien, Robert W. Lord, Mark A. Malamud, John D. Rinaldo Jr., and Lowell L. Wood, Jr., as inventors, U.S. Ser. No. 11/347,804, filed Feb. 3, 2006.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present applicant entity has provided above a specific reference to the application(s)from which priority is being claimed as recited by statute. Applicant entity understands that the statute is unambiguous in its specific reference language and does not require either a serial number or any characterization, such as “continuation” or “continuation-in-part,” for claiming priority to U.S. patent applications. Notwithstanding the foregoing, applicant entity understands that the USPTO's computer programs have certain data entry requirements, and hence applicant entity is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent that such subject matter is not inconsistent herewith.

### TECHNICAL FIELD

This description relates to data handling techniques.

### SUMMARY

An embodiment provides a method. In one implementation, the method includes but is not limited to receiving a request for a treatment option, the request associated with at least one query parameter, determining at least one treatment parameter, based on the request, the at least one treatment parameter including at least one target-related tissue ancestry-correlated binding site and/or at least one target-related tissue ancestry-correlated binding agent, and providing the treatment option, based on the at least one treatment parameter and the at least one query parameter. In addition to the foregoing, other method aspects are described in the claims, drawings, and text forming a part of the present disclosure.

An embodiment provides a computer program product. In one implementation, the computer program product includes but is not limited to a signal-bearing medium bearing at least one of one or more instructions for receiving a request for a treatment option, the request associated with at least one query parameter, the signal bearing medium bearing one or more instructions for determining at least one treatment parameter, based on the request, the at least one treatment parameter including at least one target-related tissue ancestry-correlated binding site and/or at least one target-related tissue ancestry-correlated binding agent, and the signal bearing medium bearing one or more instructions for providing the treatment option, based on the at least one treatment parameter and the at least one query parameter. In addition to the foregoing, other computer program product aspects are described in the claims, drawings, and text forming a part of the present disclosure.

An embodiment provides a system. In one implementation, the system includes but is not limited to a computing device and instructions. The instructions when executed on the computing device cause the computing device to receive a request for a treatment option, the request associated with at least one query parameter, determine at least one treatment parameter, based on the request, the at least one treatment parameter including at least one target-related tissue ancestry-correlated binding site and/or at least one target-related tissue ancestry-correlated binding agent, and provide the treatment option, based on the at least one treatment parameter and the at least one query parameter. In addition to the foregoing, other system aspects are described in the claims, drawings, and text forming a part of the present disclosure.

An embodiment provides a device. In one implementation, the device includes but is not limited to a treatment system, and the treatment system includes but is not limited to a treatment data memory that is operable to store treatment data including at least one treatment parameter, the at least one treatment parameter including at least one target-related tissue ancestry-correlated binding site and/or at least one target-related tissue ancestry-correlated binding agent, and treatment logic that is operable to determine the at least one treatment parameter, based on a request associated with at least one query parameter, and to determine a treatment option, based on the at least one treatment parameter and the at least one query parameter. In addition to the foregoing, other device aspects are described in the claims, drawings, and text forming a part of the present disclosure.

In addition to the foregoing, various other embodiments are set forth and described in the text (e.g., claims and/or detailed description) and/or drawings of the present description.

The foregoing is a summary and thus contains, by necessity, simplifications, generalizations and omissions of detail; consequently, those skilled in the art will appreciate that the summary is illustrative only and is not intended to be in any way limiting. Other aspects, features, and advantages of the devices and/or processes described herein, as defined by the claims, will become apparent in the detailed description set forth herein.

### BRIEF DESCRIPTION OF THE DRAWINGS

FIG. 1 illustrates an example clinical system in which embodiments may be implemented, perhaps in a device.

FIG. 2 illustrates certain alternative embodiments of the clinical system of FIG. 1.

FIG. 3 illustrates an alternative embodiment of treatment data associated with the clinical system of FIG. 1.

FIG. 4 illustrates another alternative embodiment of treatment data associated with the clinical system of FIG. 1.

FIG. 5 illustrates another alternative embodiment of treatment data associated with the clinical system of FIG. 1, with specific examples of treatment data.

FIG. 6 illustrates additional alternative embodiments of treatment data associated with the clinical system of FIG. 1, with specific examples of treatment data.

FIG. 7 illustrates additional alternative embodiments of treatment data associated with the clinical system of FIG. 1, with specific examples of treatment data.

FIG. 8 illustrates an example screenshot of a graphical user interface for search techniques related to tissue coding.

FIG. 9 illustrates an alternative embodiment of the clinical system of FIG. 1 in which the clinical system is configured to provide searching related to tissue coding.

FIG. 10 illustrates an operational flow representing example operations related to search techniques related to tissue coding.

FIG. 11 illustrates an alternative embodiment of the example operational flow of FIG. 10.

FIG. 12 illustrates an alternative embodiment of the example operational flow of FIG. 10.

FIG. 13 illustrates an alternative embodiment of the example operational flow of FIG. 10.

FIG. 14 illustrates an alternative embodiment of the example operational flow of FIG. 10.

FIG. 15 illustrates an alternative embodiment of the example operational flow of FIG. 10.

FIG. 16 illustrates an alternative embodiment of the example operational flow of FIG. 10.

FIG. 17 illustrates an alternative embodiment of the example operational flow of FIG. 10.

FIG. 18 illustrates an alternative embodiment of the example operational flow of FIG. 10.

FIG. 19 illustrates a partial view of an example computer program product that includes a computer program for executing a computer process on a computing device.

FIG. 20 illustrates an example system in which embodiments may be implemented.

The use of the same symbols in different drawings typically indicates similar or identical items.

### DETAILED DESCRIPTION

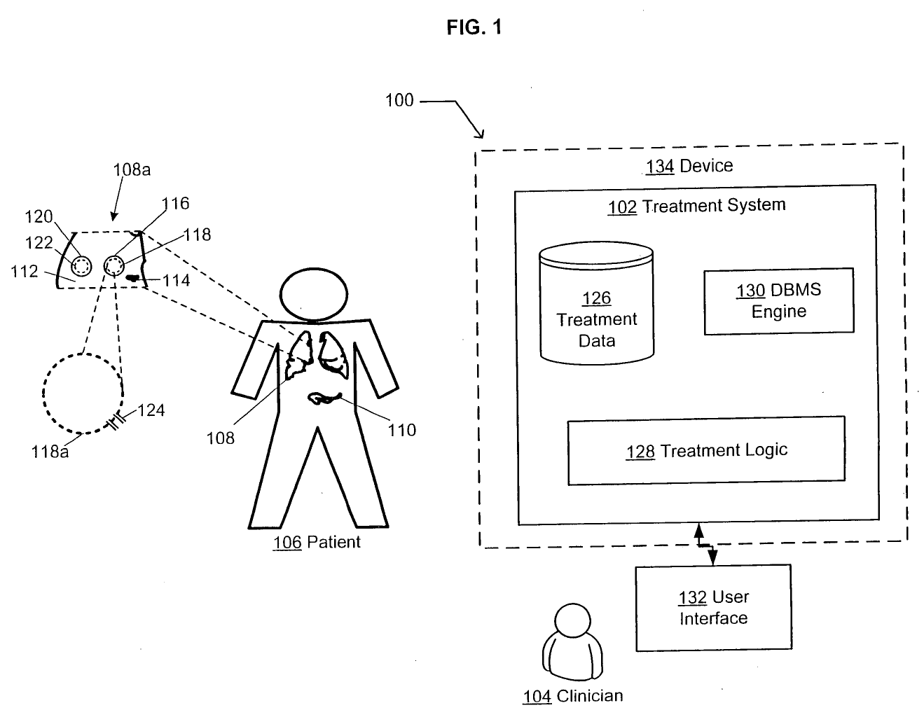

FIG. 1 illustrates an example clinical system 100 in which embodiments may be implemented. The clinical system 100 includes a treatment system 102. The treatment system 102 may be used, for example, to store, recall, access, process, implement, or otherwise use information that is beneficial in a clinical setting(s). For example, the treatment system 102 may be used to diagnose or treat patients by storing and/or providing information as to whether or how treatment agent(s) may be applied to a specific region(s) of interest of the human body, such as, for example, a lobe of the lungs, breast tissue, cancerous tissue at a certain bodily location, or other such regions of interest. As a further example, the treatment system 102 may provide information as to whether and/or how to minimize or avoid application of such treatment agents to regions of non-interest (for example, regions to which the treatment agent(s) should not be applied, in order to avoid, e.g., problematic side effects and other undesired results). On the basis of such clinical information, for example, targeted applications of treatment agents (e.g., medication, imaging agents, or other beneficial medical agents) may be carried out in a manner that achieves a desired outcome, while minimizing or eliminating unwanted applications to non-targeted bodily regions.

In FIG. 1, the treatment system 102 is used by a clinician 104. The clinician 104 may, for example, use the treatment system 102 to enter, store, request, or access clinical information such as, for example, the various examples provided herein. The clinician 104 may generally represent, for example, any person involved in health care, including, for example, a doctor, a nurse, a physician's assistant, or a medical researcher. The clinician 104 also may represent someone who is involved in health care in the sense of developing, managing, or implementing the treatment system 102, e.g., a software developer with clinical knowledge (or access to clinical knowledge), a database manager, or an information technologies specialist. Even more generally, some or all of various functions or aspects described herein with respect to the clinician 104 may be performed automatically, e.g., by an appropriately-designed and implemented computing device, or by software agents or other automated techniques.

A patient 106 generally represents any person with an illness, injury, or disease, or who is thought to potentially have such an illness, injury, or disease, or who may be wholly or partially healthy but who is nonetheless studied in order to determine information about such an illness, injury, or disease. The patient 106 also may represent or include other diagnostic and/or animal subjects that may be used in order, for example, to determine an efficacy of a particular medication or treatment, specific examples of which are provided herein. The patient 106 may represent a particular patient in a given clinical setting, such as in a doctor's office, or in a hospital, who is to be diagnosed and/or treated using the treatment system 102. The patient 106 also may represent the more abstract notion of a class of patients (e.g., patients having a certain age, gender, race, genetic makeup, or disposition to illness or disease), or, even more generally, may represent the general notion of a generic patient during basic research and/or development or application of various medical treatments or procedures. In this latter sense, the patient 106 may also represent a non-human animal (such as a primate) believed to be sufficiently similar to a human for the particular purposes that they may usefully substitute for such for the particular purposes.

As such, the patient 106 generally possesses or is associated with, for example, some or all of the various organs, systems, organ systems, organ subsystems, diseased tissue, and/or healthy tissue that may be found in the body. In FIG. 1, the patient 106 is illustrated as having a lung 108 and a pancreas 110, so that these (and other) body parts may be used as the bases for the specific examples given herein. Of course, many other applications of the treatment system 102 exist, over and above the examples provided herein.

In an exploded portion 108a of the lung 108, various example elements are illustrated, although not drawn to scale for the purposes of clarity and ease of illustration and description. For example, the lung 108 may include a healthy tissue portion 112, and a diseased tissue portion 114. The healthy tissue 112 may include, for example, healthy lung tissue, while the diseased tissue 114 may include, for example, a tumor or other cancerous tissue.

The lung 108 also may include a blood vessel 116, which is illustrated in a cut-away view, and which includes a tissue component 118 known as, by way of example nomenclature, the endothelium, endothelial layer, or endothelial cells. The endothelium or endothelial layer 118 generally refers to a layer of cells that lines an interior of a portion of the circulatory system, such as the blood vessel 116. In FIG. 1, the blood vessel 116 and the endothelial layer 118 are illustrated as being in the vicinity of the diseased tissue 114. In contrast, an example of a blood vessel 120 is illustrated that contains endothelial layer 122. The blood vessel 120 is shown as being in the vicinity of the healthy tissue 112 of the lung 108.

Certain properties of the endothelial layer 118 and the endothelial layer 122 may enable the targeted delivery of one or more treatment agents to a vicinity of the diseased tissue 114 and the healthy tissue 112, respectively. For example, blood (and other cells contained therein) will be transported within and along a length of the blood vessel 116, where the length of the blood vessel 116 naturally extends a relatively long distance in either direction toward/away from the diseased tissue 114. However, cells of the endothelial layer 118 that have developed and/or grown over a period of time in a vicinity of the diseased tissue 114 may exhibit characteristics that are unique, or essentially unique, to a site on the endothelial layer 118 in that particular vicinity.

For example, the diseased tissue 114 may include a tumor that has grown over a period of time. During that period of time, a corresponding growth or development of a site on the endothelial layer 118 may reflect, or otherwise be correlated with and/or affected by, the growth of the diseased tissue (tumor) 114. This correlation between the history or ancestry of the site on the endothelial layer 118 in the vicinity of the diseased tissue 114 may result in unique, or almost unique, properties of the tissue ancestry-correlated site, such as, for example, a display of specific and identifiable proteins. Moreover, similar comments may apply to a tissue ancestry-correlated site along the endothelial layer 122 of the blood vessel 120, in the vicinity of the healthy tissue 112. In this way, each such tissue ancestry-correlated site, whether in the lung or in other sites in the body, may be used to provide, effectively, a molecular-level address that specifies a location within the body, e.g., a location of the diseased tissue 114 and/or the healthy tissue 112.

Other mechanisms exist by which such effective molecular-level addresses, such as those that may, in some instances, entail some logical relation to tissue ancestry-correlated sites, may arise at a given location in the body. For example, such sites may originate in or at a first location in the body, and may thereafter undergo transport to, and engraftment/implantation at, a second location in the body. For example, tissue may originate in bone marrow, or in a distant neoplasm, and may be transported through the vasculature to another, second location in the body (e.g., the lungs 108). Such tissue, which may be, for example, as small as a single cell, may embed at the second location and thereafter serve as a molecular-level address or site to which other agent(s) may bind.

Accordingly, such tissue ancestry-correlated sites may be used to direct treatment agents (such as, for example, medications, imaging agents, or radio-immunotherapy agents) in a desired fashion. For example, as described in more detail in certain examples provided herein, radionuclides may be applied to the diseased tissue 114.

In this regard, it should be understood that, without use of the tissue ancestry-correlated site(s) described herein, it may be difficult to direct such treatment agents to desired body regions with a necessary or desired level of precision. For example, many treatment agents may be delivered by injection (or by other delivery modalities, e.g., swallowing or absorption through the skin) into a bloodstream of the patient 106. However, without an effective way to direct the treatment agents once in the bloodstream, a positive impact of the treatment agents may be reduced or eliminated. Moreover, ancillary delivery of the treatment agents to undesired regions (e.g., delivery of radionuclides to the healthy tissue 112 and/or to the pancreas 110 or other organs) may result in harm to the patient 106. Such harm may be particularly acute or problematic in cases where, for example, a concentration, dosage, or amount of the treatment agent in the bloodstream is required to be increased relative to an optimal treatment amount, simply to ensure that some portion of the treatment agent reaches and affects a desired end target. Similar comments may apply to other treatment modalities. For example, treatment of the diseased tissue 114 (e.g., a tumor) may be performed by radiation therapy in which the patient is exposed to radiation, and, again, the net effect of such treatment(s) may be negative due to harm caused by the radiation to the healthy tissue 112.

As just described, then, tissue ancestry-correlated sites may exist within and along the endothelial layers 118 and/or 122, in the vicinity of correlated tissues that may serve as target(s) (e.g., the diseased tissue 114) for certain treatment agent(s). For example, these target-related tissue ancestry-correlated sites may include, as described herein, certain proteins that may be known to bind to/with certain other agents. In one specific example discussed herein, a target-related tissue ancestry-correlated binding site includes a protein, aminopeptidase-P (APP), that is known to bind with an agent such as, for example, I-labeled monoclonal antibodies. If a treatment agent (such as, for example, radionuclides) is associated with the target-related tissue ancestry-correlated binding agent (e.g., the I-labeled monoclonal antibodies), then injection of the target-related tissue ancestry-correlated binding agent into the bloodstream will result in delivery of the treatment agent (e.g., radionuclides) to the target-related tissue ancestry-correlated binding site (e.g., APP in the vicinity of the lung 108). That is, as the target-related tissue ancestry-correlated binding agent moves through the bloodstream, the target-related tissue ancestry-correlated binding agent will bind with the target-related tissue ancestry-correlated binding site in the vicinity of the, in this example, diseased tissue 114, thus resulting in effective application of the attached treatment agent in the desired region of the body of the patient 106.

In many cases, delivery of the treatment agent(s) to the vicinity of desired body regions, by delivering the treatment agents to defined sites along a blood vessel wall(s) in the desired vicinity, may be sufficient to obtain a desired result, even if the treatment agents are continually contained within the blood vessel(s) at the target-related tissue ancestry-correlated binding sites. In various cases, treatment agent delivery should occur with greater or lesser levels of specificity and/or efficacy. For example, in some cases, it may be sufficient to provide the treatment agent in the lung 108, while in other cases the treatment agent must or should be applied substantially only to the diseased tissue 114.

Additionally, in some cases, it may be possible and/or desirable to breach or penetrate a wall of the blood vessel(s) 116/120, in order to reach associated tissue(s) directly. For example, in FIG. 1, an enlarged view 118a of the endothelial layer 118 is illustrated that includes a mechanism by which the treatment agents may directly access a direct end target of tissue (e.g., the diseased tissue 114). Specifically, FIG. 1 illustrates a mechanism 124 that may include, for example, structures known as caveolae. Although the mechanism (e.g., caveolae) 124 are shown conceptually in FIG. 1 as tubes or access points, caveolae generally refer to small invaginations of a surface of the blood vessel 116 that carry out certain transport and/or signaling functions between cells within the blood vessel 116 and cells outside of the blood vessel 116 (e.g., the diseased tissue 114). Further discussion regarding caveolae 124 is provided in various examples, herein.

Although many other examples are provided herein and with reference to the various figures, it should be understood that many types and instances of treatment data may play a role in the use and application of the various concepts referenced above and described in more detail herein. The treatment system 102 may store such treatment data 126 in a database or other memory, for easy, convenient, and effective access by the clinician 104.

The treatment data 126 may include, for example, not only the target-related tissue ancestry-correlated binding site(s) and/or the related target-related tissue ancestry-correlated binding agent(s), but also various other parameters and/or characteristics related to treatment of the patient 106, examples of which are provided herein. Through detailed storage, organization, and use of the treatment data 126, the clinician 104 may be assisted in determining optimal treatment techniques for the patient 106, in order, for example, to select and deliver an appropriate type and/or level of a treatment agent, with an appropriate degree of accuracy, to a desired end target (based on an appropriate target-related tissue ancestry-correlated binding site and/or an appropriate target-related tissue ancestry-correlated binding agent), while minimizing any negative impact of such a selection/delivery, if any, on other regions of the body of the patient 106. Ordered assignment and/or storage of information within the treatment data 126, as described herein, facilitates and/or enables such recall, access, and/or use of the treatment data by the clinician 104 in treating the patient 106.

In the treatment system 102, treatment logic 128 may be used to store, organize, access, recall, or otherwise use the information stored in the treatment data 126. For example, the treatment logic 128 may access a database management system (DBMS) engine 130, which may be operable to perform computing operations to insert or modify new data into/within the treatment data 126, perhaps in response to new research or findings, or in response to a preference of the clinician 104. For example, if a new treatment agent is discovered to be effective on the diseased tissue 114, the clinician 104 may access the treatment system 102 using a user interface 132, in order to use the DBMS engine 130 to associate the new treatment agent with one or more instances of the target-related tissue ancestry-correlated binding site(s) and/or target-related tissue ancestry-correlated binding agent(s) that may be known to be useful in targeting the diseased tissue 114, within the treatment data database 126 (assuming that the treatment agent is suitable for direct or indirect delivery via the target-related tissue ancestry-correlated binding agent, as described herein). As another example, if a new target-related tissue ancestry-correlated binding site is identified in the endothelial layer 118 in the vicinity of the diseased tissue 114, then this new target-related tissue ancestry-correlated binding site may be associated with one or more instances of a target-related tissue ancestry-correlated binding agent, e.g., there may be more than one agent that is useful in attaching to the new target-related tissue ancestry-correlated binding site for delivery of one or more treatment agents.

Similarly, in a case where the clinician 104 seeks, for example, to diagnose or treat the patient 106, the clinician 104 may access the user interface 132 to use the treatment logic 128 and/or the DBMS Engine 130 to determine best known methods or treatments to be applied in a given clinical scenario. For example, if the patient 106 has a certain type of disease or illness in a certain region of the body, then the clinician may input this information via the user interface 132 in order to obtain one or more options for treating the disease or illness. For example, if the patient 106 exhibits the diseased tissue 114, then the clinician 104 may select the (type of) diseased tissue 114 in the lung 108 as an end target, and the treatment logic 128 may then interface with the DBMS engine 130 to obtain, from the treatment data 126, one or more options for providing the treatment agent to the diseased tissue 114, e.g., one or more target-related tissue ancestry-correlated binding sites (such as, for example, two different proteins that are expressed or displayed in the endothelial layer 118 in the vicinity of the diseased tissue 114). As another example, if the clinician 104 is already aware of a target-related tissue ancestry-correlated binding site in the vicinity of the diseased tissue 114, then the clinician 104 may input this information into the treatment system 102 and be provided with one or more, for example, target-related tissue ancestry-correlated binding agents that may be known to attach to the known target-related tissue ancestry-correlated binding site.

In this regard, it should be understood that multiple instances of a target-related tissue ancestry-correlated binding site, as described, may be present at any one location in the body, and, moreover, virtually any region or site in the body having a blood-tissue interface may also exhibit an associated, target-related tissue ancestry-correlated binding site. Further, new instances of target-related tissue ancestry-correlated binding sites may be discovered and/or approved for clinical use on a relatively frequent basis. Still further, there may be many different treatment parameters and/or characteristics that may be related to the various target-related tissue ancestry-correlated binding site(s) and/or target-related tissue ancestry-correlated binding agent(s), such as, for example, treatment agents and/or delivery mechanisms.

As a result, the clinician 104, e.g., a physician in the field, may not be aware of all currently-available content of the treatment data 126. Thus, the treatment system 102 provides the clinician with readily-available, accurate, current, and/or comprehensive treatment information, and also provides techniques to ensure that the treatment information remains accurate, current, and/or comprehensive, by allowing the addition and/or modification of the existing treatment data 126, as new treatment information becomes available.

In FIG. 1, the treatment system 102 is illustrated as possibly being included within a device 134. The device 134 may include, for example, a mobile computing device, such as a personal digital assistant (PDA), or a laptop computer. Of course, virtually any other computing device may be used to implement the treatment system 102, such as, for example, a workstation, a desktop computer, or a tablet PC.

Additionally, not all of the treatment system 102 need be implemented on a single computing device. For example, the treatment data 126 may be stored on a remote computer, while the user interface 132 and/or treatment logic 128 are implemented on a local computer. Further, aspects of the treatment system 102 may be implemented in different combinations and implementations than that shown in FIG. 1. For example, functionality of the DBMS engine 130 may be incorporated into the treatment logic 128 and/or the treatment data 126.

The treatment data 126 may be stored in virtually any type of memory that is able to store and/or provide access to information in, for example, a one-to-many, many-to-one, and/or many-to-many relationship. Such a memory may include, for example, a relational database and/or an object-oriented database, examples of which are provided in more detail herein.

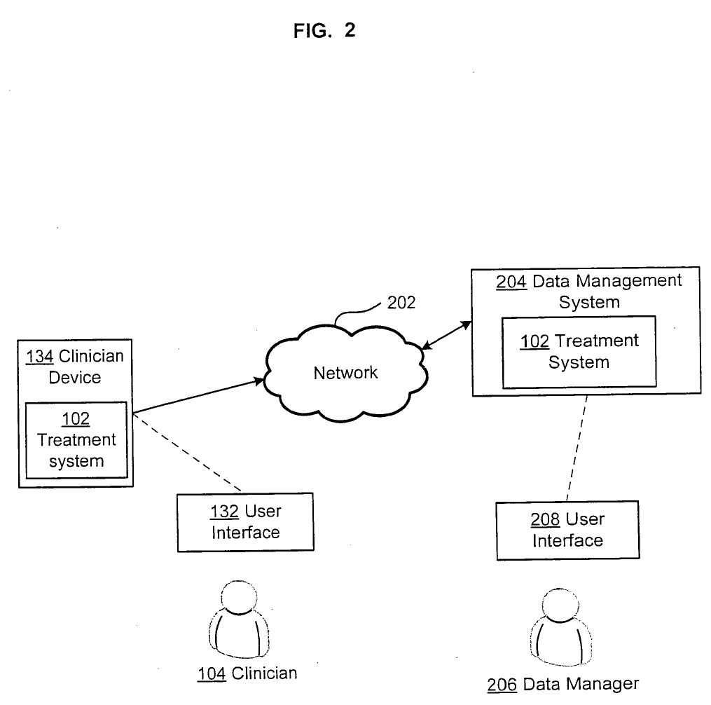

FIG. 2 illustrates certain alternative embodiments of the clinical system 100 of FIG. 1. In FIG. 2, the clinician 104 uses the user interface 132 to interact with the treatment system 102 deployed on the clinician device 134. The clinician device 134 is in communication over a network 202 with a data management system 204, which is also running the treatment system 102; the data management system 204 may be interacted with by a data manager 206 through a user interface 208. Of course, it should be understood that there may be many clinicians other then the specifically-illustrated clinician 104, each with access to an individual implementation of the treatment system 102. Similarly, multiple data management systems 204 may be implemented.

In this way, the clinician 104, who may be operating in the field, e.g., in an office and/or hospital environment, may be relieved of a responsibility to update or manage contents in the treatment data 126, or other aspects of the treatment system 102. For example, the data management system 204 may be a centralized system that manages a central database of the treatment data 126, and/or that deploys or supplies updated information from such a central database to the clinician device 134.

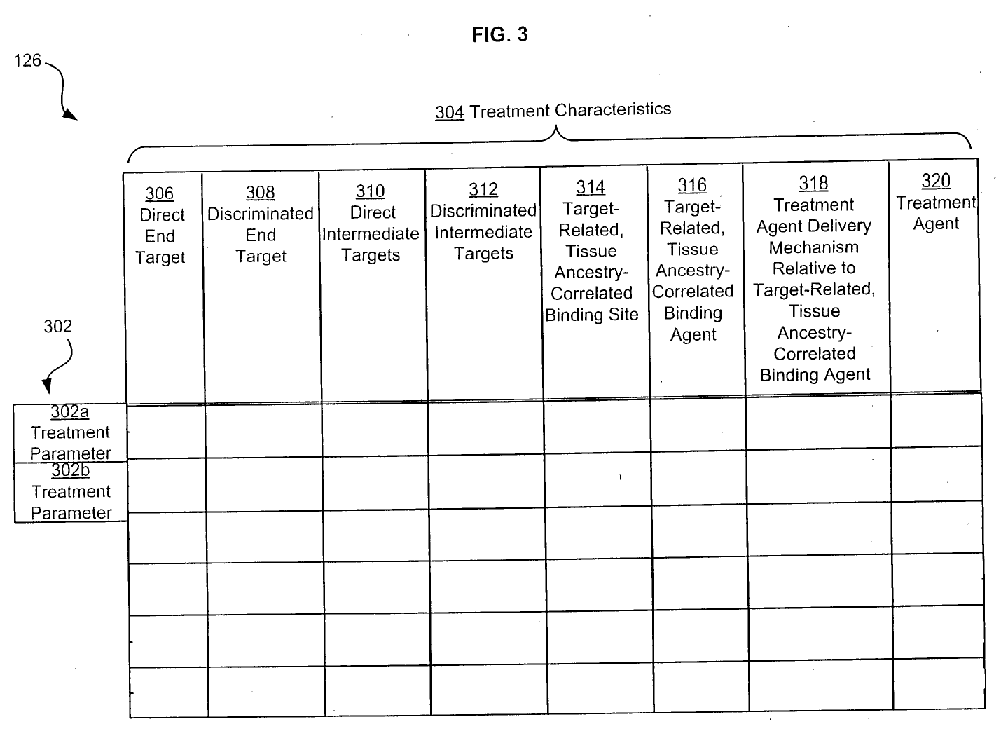

FIG. 3 illustrates an alternative embodiment of the treatment data 126 associated with the clinical system 100 of FIG. 1. In FIG. 3, and in the various examples herein, a particular nomenclature is used for the terms described above and related terms, in order to provide consistency and clarity of description. However, it should be understood that other terminology may be used to refer to the same or similar concepts.

In FIG. 3, treatment parameters 302 are stored and organized with respect to a plurality of treatment characteristics 304. The treatment characteristics 304 include many of the terms and concepts just described, as well as additional, but not exhaustive, terms and concepts that may be relevant to a use and operation of the treatment system 102.

For example, the treatment characteristics 304 include a direct end target 306. The direct end target 306 may refer, for example, to any tissue, organ, organ system, organ subsystem (or type thereof), or any other body part or region that may be targeted for healing, destruction, repair, enhancement, and/or imaging that may be targeted—directly or indirectly—via an associated target-related tissue ancestry-correlated binding site 314 and/or an associated target-related tissue ancestry-correlated binding agent 316 and/or an associated treatment agent delivery mechanism relative to the target-related tissue ancestry-correlated binding agent 318 and/or an associated treatment agent 320. A discriminated end target 308 refers to targets that should be avoided during implementation of the healing, destruction, repair, enhancement and/or imaging actions that may be discriminated—directly or indirectly—via an associated target-related tissue ancestry-correlated binding site 314 and/or an associated target-related tissue ancestry-correlated binding agent 316 and/or an associated treatment agent delivery mechanism relative to the target-related tissue ancestry-correlated binding agent 318 and/or an associated treatment agent 320. For example, in FIG. 1, the lung 108 may include the direct end target 306 as the diseased tissue 114, and may include the discriminated end target 308 as the healthy tissue 112, and/or the pancreas 110.

Somewhat analogously, a direct intermediate target 310 refers to targets that are connected to, associated with, or in the vicinity of the direct end target that may be targeted via an associated target-related tissue ancestry-correlated binding site 314 and/or an associated target-related tissue ancestry-correlated binding agent 316 and/or an associated treatment agent delivery mechanism relative to the target-related tissue ancestry-correlated binding agent 318 and/or an associated treatment agent 320. For example, a portion of the endothelial layer 118 in a vicinity of the diseased tissue 114 (or other end target) may act as a direct intermediate target 310. Then, a discriminated intermediate target 312 may refer to endothelial tissue of the layer 118 that is not in a vicinity of the diseased tissue 114 that may be discriminated via an associated target-related tissue ancestry-correlated binding site 314 and/or an associated target-related tissue ancestry-correlated binding agent 316 and/or an associated treatment agent delivery mechanism relative to the target-related tissue ancestry-correlated binding agent 318 and/or an associated treatment agent 320.

As already referenced, a target-related tissue ancestry-correlated binding site 314 refers to a determined chemical and/or genetic and/or biological structure to which various chemical compounds and/or genes may be affixed. For example, the target-related tissue ancestry-correlated binding site 314 may include a specific protein that is displayed at the endothelial layer 118 in a vicinity of the diseased tissue 114. The target-related tissue ancestry-correlated binding site 314 may be selectively associated with the direct end target 306 either directly or through the direct intermediate target 310.

A target-related tissue ancestry-correlated binding agent 316, then, may refer to some specific chemical and/or genetic and/or biological structure that more or less selectively binds or attaches to a related one of the target-related tissue ancestry-correlated binding sites 314. The target-related tissue ancestry-correlated binding agent 316 also may be associated with a treatment agent delivery mechanism relative to the target-related tissue ancestry-correlated binding agent 318, which may refer either to something that may be directly attached to (or associated with) the target-related tissue ancestry-correlated binding agent 316, and/or something that may be attached to (or associated with) one or more intermediary or indirect structures that attach to the target-related tissue ancestry-correlated binding agent 316 and that act to house and/or deliver a treatment agent 320. As an example of the intermediary or indirect structures just referenced, a nano-container may be used that dissolves and/or otherwise opens in a vicinity of the target-related tissue ancestry-correlated binding site 314, and thereby releases and/or delivers the treatment agent 320 included inside.

The treatment agent 320 thus binds/attaches to, or otherwise is associated with, either directly or indirectly, the target-related tissue ancestry-correlated binding agent 316. Thus, as described, the treatment agent 320 may be effectively transported to the appropriate direct intermediate target 310 and thereby to the target-related tissue ancestry-correlated binding site 314. In this way, the treatment agent 320 may be delivered to the direct end target 306 (or at least to a vicinity of the direct end target 306), while not being delivered either to the discriminated intermediate target(s) 312 and/or the discriminated end target(s) 308.

FIG. 3 thus illustrates that there may be many different relationships or associations between any one (or more) of the treatment characteristics 304. For example, one or more instances of any one or more of the treatment characteristics 304 may be considered to be one of the treatment parameters 302, and thereafter associated with one or more instances of the remaining treatment characteristics 304. For example, the direct end target 306 may be considered to be the treatment parameter(s) 302, where a first instance 302a of the direct end target 306 may refer to diseased lung tissue, and the second instance 302b may refer to diseased breast tissue, and both instances may be associated with an instance of the target-related tissue ancestry-correlated binding agent 316. Similarly, two or more instances of the target-related tissue ancestry-correlated binding agent 316 (e.g., I-labeled APP monoclonal antibodies targeted on two different antigens) may be associated with one treatment agent 320 (e.g., radio-immunotherapy via application of low levels of radionuclides).

Many other examples of relationships and associations between the various treatment parameters 302 and/or the treatment characteristics 304 (and/or other treatment information) may be defined or determined and stored in the treatment data 126 according to the treatment logic 128. Certain of these examples are provided herein.

Additionally, although the treatment data 126 is illustrated conceptually in FIG. 3 as a flat table in which one or more of the selected treatment parameters 302 are associated with one or more of the treatment characteristics, it should be understood that this illustration is for explanation and example only, and is not intended to be limiting in any way with respect to the various ways in which the treatment data 126 may be stored, organized, accessed, recalled, or otherwise used.

For example, the treatment data 126 may be organized into one or more relational databases. In this case, for example, the treatment data 126 may be stored in one or more tables, and the tables may be joined and/or cross-referenced in order to allow efficient access to the information contained therein. Thus, the treatment parameter(s) 302 may define a record of the database(s) that is associated with various ones of the treatment characteristics 304.

In such cases, the various tables may be normalized so as, for example, to reduce or eliminate data anomalies. For example, the tables may be normalized to avoid update anomalies (in which the same information would need to be changed in multiple records, and which may be particularly problematic when treatment data database 126 is large), deletion anomalies (in which deletion of a desired field or datum necessarily but undesirably results in deletion of a related datum), and/or insertion anomalies (in which insertion of a row in a table creates an inconsistency with another row(s)). During normalization, an overall schema of the database may be analyzed to determine issues such as, for example, the various anomalies just referenced, and then the schema is decomposed into smaller, related schemas that do not have such anomalies or other faults. Such normalization processes may be dependent on, for example, desired schema(s) or relations between the treatment parameters 302 and/or treatment characteristics 304, and/or on desired uses of the treatment data 126.

Uniqueness of any one record in a relational database holding the treatment data 126 may be ensured by providing or selecting a column of each table that has a unique value within the relational database as a whole. Such unique values may be known as primary keys. These primary keys serve not only as the basis for ensuring uniqueness of each row (e.g., treatment parameter) in the database, but also as the basis for relating or associating the various tables within one another. In the latter regard, when a field in one of the relational tables matches a primary key in another relational table, then the field may be referred to a foreign key, and such a foreign key may be used to match, join, or otherwise associate (aspects of) the two or more related tables.

FIG. 3 and associated potential relational databases represent only one example of how the treatment data may be stored, organized, processed, accessed, recalled, and/or otherwise used.

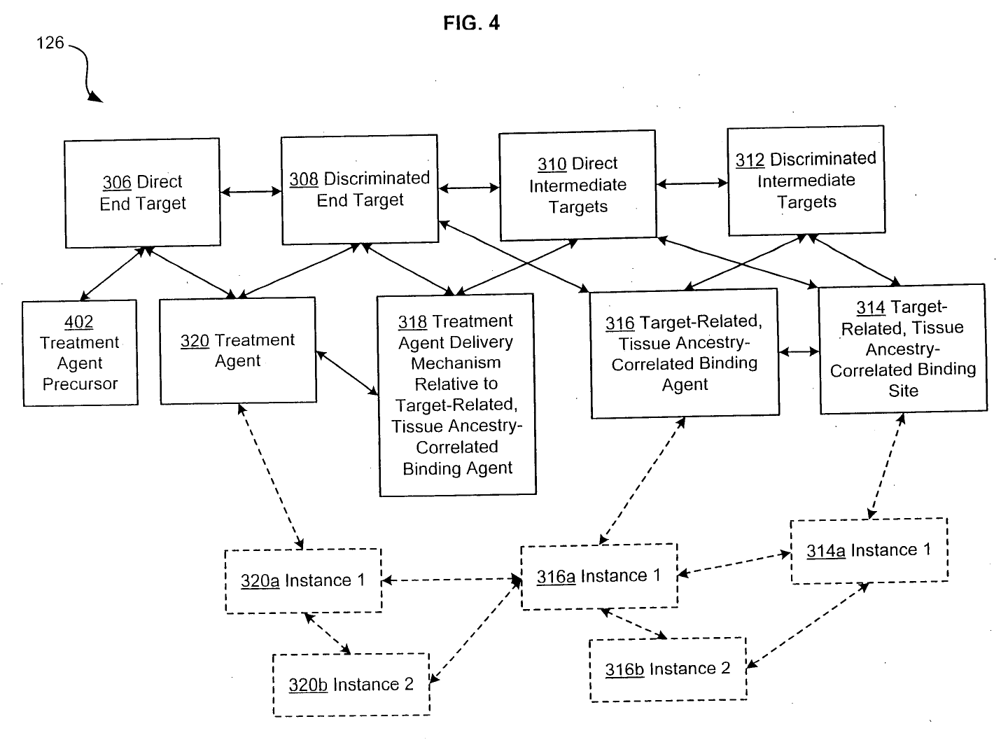

FIG. 4 illustrates another alternative embodiment of treatment data 126 associated with the clinical system 100 of FIG. 1, in which the treatment data 126 is conceptually illustrated as being stored in an object-oriented database.

In such an object-oriented database, the various treatment parameter(s) 302 and/or treatment characteristic(s) 304, and/or instances thereof, may be related to one another using, for example, links or pointers to one another. FIG. 4 illustrates a conceptualization of such a database structure in which the various types of treatment data are interconnected, and is not necessarily intended to represent an actual implementation of an organization of the treatment data 126.

The concepts described above may be implemented in the context of the object-oriented database of FIG. 4. For example, two instances 320a and 320b of the treatment agent 320 may be associated with one (or more) instance 316a of the target-related tissue ancestry-correlated binding agent 316. Meanwhile, two instances 316a and 316b of the target-related tissue ancestry-correlated binding agent 316 may be associated with an instance 314a of the target-related tissue ancestry-correlated binding site 314.

Also, other data may be included in the treatment data 126. For example, in FIG. 4, a treatment agent precursor 402 is shown that refers generally to an agent used to facilitate application of the treatment agent 320, e.g., an immune-response element that is used to identify/mark/bond with the target-related tissue ancestry-correlated binding site 314 and/or a substance that when metabolized becomes treatment agent 320, such as with prodrugs.

Many other examples of databases and database structures also may be used. Other such examples include hierarchical models (in which data are organized in a tree and/or parent-child node structure), network models (based on set theory, and in which multi-parent structures per child node are supported), or object/relational models (combining the relational model with the object-oriented model).

Still other examples include various types of eXtensible Mark-up Language (XML) databases. For example, a database may be included that holds data in some format other than XML, but that is associated with an XML interface for accessing the database using XML. As another example, a database may store XML data directly. Additionally, or alternatively, virtually any semi-structured database may be used, so that context may be provided to/associated with stored data elements (either encoded with the data elements, or encoded externally to the data elements), so that data storage and/or access may be facilitated.

Such databases, and/or other memory storage techniques, may be written and/or implemented using various programming or coding languages. For example, object-oriented database management systems may be written in programming languages such as, for example, Cut or Java. Relational and/or object/relational models may make use of database languages, such as, for example, the structured query language (SQL), which may be used, for example, for interactive queries for information and/or for gathering and/or compiling data from the relational database(s).

As referenced herein, the treatment system 102 may be used to perform various data querying and/or recall techniques with respect to the treatment data 126, in order to facilitate treatment and/or diagnosis of the patient 106. For example, where the treatment data are organized, keyed to, and/or otherwise accessible using one or more of the treatment parameters 302 and/or treatment characteristics 304, various Boolean, statistical, and/or semi-Boolean searching techniques may be performed.

For example, SQL or SQL-like operations over one or more of the treatment parameters 302/treatment characteristics 304 may be performed, or Boolean operations using the treatment parameters 302/treatment characteristics 304 may be performed. For example, weighted Boolean operations may be performed in which different weights or priorities are assigned to one or more of the treatment parameters 302/treatment characteristics 304, perhaps relative to one another. For example, a number-weighted, exclusive-OR operation may be performed to request specific weightings of desired (or undesired) treatment data to be included (excluded).

For example, the clinician 104 may wish to determine examples of the direct end target 306 that are associated with examples of the discriminated end target 308 that are highly discriminated against with respect to delivery of the target-related tissue ancestry-correlated binding agent 316, for highly-specific delivery of the treatment agent 320. For example, the clinician 104 may want to know instances of the treatment agent 320 that may be delivered to the lungs as the direct end target 306, without substantially affecting the pancreas, liver, or other tissue, organ, or organ system/subsystem. In other examples, the clinician may be willing to tolerate lower levels of discrimination (e.g., increased delivery of the treatment agent 320 to other body regions), perhaps because the patient 106 is in an advanced stage of illness. As another example, the clinician 104 may start with a preferred (type of) the treatment agent 320, and may request from the treatment system 102 various delivery techniques (e.g., target-related tissue ancestry-correlated binding agent 316) that may be available, perhaps with varying levels of efficacy.

The clinician 104 may specify such factors using, for example, the user interface 132. For example, the clinician 104 may be able to designate one or more of the treatment parameters 302/treatment characteristics 304, and assign a weight or importance thereto, using, for example, a provided ranking system. In this regard, and as referenced herein, it should be understood that the clinician 104 may wish to deliver a particular instance of the treatment agent 320, e.g., a particular radionuclide to be delivered to a tumor. However, such a treatment agent, if applied by conventional techniques, may be problematic or prohibited (e.g., where a current physiological condition of the patient 106 and/or state of an immune system of the patient 106 is insufficient to allow the clinician 104 to use the desired treatment agent). Moreover, the clinician 104 may not be aware that a suitable target-related tissue ancestry-correlated binding site 314 and/or target-related tissue ancestry-correlated binding agent 316 has (have) been discovered for delivering the treatment agent with a desired/required level of accuracy. However, the clinician 104 may query the treatment system 102 based on the desired treatment agent 320, and may thereby discover the technique(s) by which the treatment agent may be applied, and with the necessary level of specificity.

Similarly, data analysis techniques (e.g., data searching) may be performed using the treatment data 126, perhaps over a large number of databases. For example, the clinician 104 may perform a physical screening of the patient 106, and may input some body system, tissue, organ, or organ system/subsystem parameters against which screening is to be performed. Then, the clinician should receive a listing of target-related tissue ancestry-correlated binding sites and/or target-related tissue ancestry-correlated binding agents that are ranked according to some criteria. For example, the clinician 104 may receive a listing of instances of the target-related tissue ancestry-correlated binding site 314 that provide a particularly high or low level of discrimination with respect to a particular direct end target 306, discriminated end target 308, and/or treatment agent 320. In this way, for example, if the patient 106 has an organ or organ subsystem that requires protection from a given instance of the treatment agent 320, then the clinician 104 may select an instance of the target-related tissue ancestry-correlated binding site 314 and/or of the target-related tissue ancestry-correlated binding agent 316 accordingly, even if some relative sacrifice of binding strength/accuracy is associated with such a selection.

By way of further example, other parameters/characteristics may be factored in. For example, elimination pathways may be tracked, databased, and/or weighted for use in the treatment data 126 and/or the treatment system 102. For example, if a particular instance of the target-related tissue ancestry-correlated binding agent is especially readily eliminated by the liver, then, in a case where the patient 106 has impaired hepatic function, such an instance may be selected for delivering the treatment agent 320, even if an otherwise superior instance of the target-related tissue ancestry-correlated binding agent 316 is known. Algorithms implementing such query/recall/access/searching techniques may thus use Boolean or other techniques to output, for example, a thresholded, rank-ordered list. The treatment logic 128 may then assign a key or other identifier to such a list(s), for easier use thereof the next time a like query is performed.

Design and testing of querying techniques in particular implementations of the treatment system 102 may involve, for example, entry of candidate treatment parameters 302/treatment characteristics 304 (or instances thereof) into a database(s), along with associated test results and/or affinity metrics that may be used to determine/weight targets or sets of targets. Then, an identifier may be generated that is unique to the target(s) set(s).

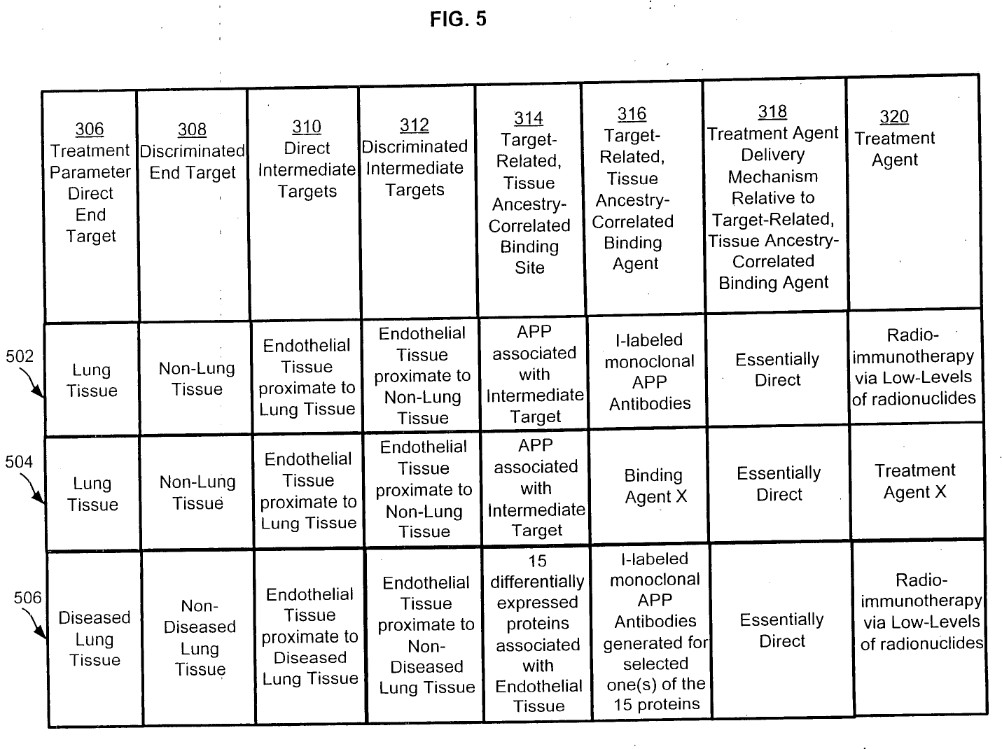

Still other examples/applications include avoiding an auto-immune response of the patient 106, in order to achieve a desired result. For example, the treatment system 102 may be used to determine/catalog/use treatment data that relates to treatment parameters 302/treatment characteristics 304 that are known or suspected to avoid self-epitopes (e.g., those unlikely to generate an undesired autoimmune response). FIG. 5 illustrates another alternative embodiment of treatment data associated with the clinical system 100 of FIG. 1, with specific examples of treatment data. In particular, all of FIGS. 5-7 provide or refer to example results from related technical papers, which are specifically referenced below.

For example, rows of the table of FIG. 5 (e.g., rows 502, 504, and 506, respectively) refer to examples that may be found in Oh, P. et al., “Subtractive Proteomic Mapping of the Endothelial Surface in Lung and Solid Tumours for Tissue-Specific Therapy,” Nature, vol. 429, pp. 629-635 (Jun. 10, 2004), which is hereby incorporated by reference in its entirety, and which may be referred to herein as the Oh reference.

In the Oh reference, it is generally disclosed that regions of endothelium may change or alter over time, based on what tissues are in the vicinity thereof, as referenced herein. The Oh reference, for example, identified lung-induced and/or lung-specific endothelial cell surface proteins based on a hypothesis that a surrounding tissue (micro) environment of the endothelial cell surface proteins modulates protein expression in the vascular endothelium. The Oh reference identified specific proteins that were found to be expressed at an endotheliae surface by specifying two regions of interest (e.g., a “lung region” and a “non-lung region”), and then determining proteins within the two regions. Then, by subtracting the two sets of proteins from one another, non-common proteins were identified.

In this way, uniquely occurring proteins at a specific endothelial site (e.g., the target-related tissue ancestry-correlated binding site 314 at a specific direct intermediate target 310) were identified. Then, these uniquely-occurring proteins were used as targets for generated antibodies. As a result, it was possible to target, for example, lung-specific tissues as opposed to non-lung-specific tissues, and/or to target tumors as opposed to non-tumor tissues. More specifically, for example, it was determined to be possible to target tumor-induced endothelial cell proteins (e.g., target-related tissue ancestry-correlated binding sites 314) for delivery thereto of drugs, imaging agents, and/or radiation agents (e.g., treatment agents 320) that were attached to appropriate antibodies (target-related tissue ancestry-correlated binding agents 316).

Thus, to set forth specific examples, a row 502 illustrates an example in which the direct end target 306 includes a treatment parameter of “lung tissue.” In this example, the discriminated end target 308 includes “non-lung tissue.” The direct intermediate target 310 includes endothelial tissues that are proximate to the lung tissue, while the discriminated intermediate target 312 includes endothelial tissue that is proximate to the non-lung tissue.

The target-related tissue ancestry-correlated binding site 314 in this example includes aminopeptidase-P (APP), which is a protein that was detected substantially only in endothelial plasma membranes from the lung tissue (e.g., direct end target 306). In order to take advantage of the immuno-accessibility of APP in vivo, I¹²⁵-labeled monoclonal antibodies were used as the target-related tissue ancestry-correlated binding agent 316, and were intravenously injected into test rats. Subsequent imaging of the lungs illustrated rapid and specific targeting of APP antibody to the lung (e.g., direct end target 306), with significantly reduced accumulation of the injected dose at non-lung tissue (e.g., the discriminated end target 308). Thus, by selecting the treatment agent 320 to include radio-immunotherapy via low levels of radionuclides (e.g., 100 μCi of I¹²⁵), a treatment agent delivery mechanism relative to target-related tissue ancestry-correlated binding agent 318 may involve essentially direct delivery, in that the radionuclide(s) may be affixed to the monoclonal APP antibodies, similarly to how the I¹²⁵ was affixed as described in Oh, et al. Further, although the term antibody is used herein in various examples, it should be understood that other immuno-reactive features of the adaptive immune system also may be used in a similar or analogous manner, including entities that serve to mediate antibody generation, such as, for example, helper T cells or dendritic cells.

In the row 504 of FIG. 5, a conceptual secondary example drawn from/based on the Oh reference is included, in order to illustrate various concepts described herein, e.g., with respect to FIGS. 1-4. Specifically, in the row 504, various ones of the treatment parameters and/or treatment characteristics are the same as in the row 502, except that a second example of the target-related tissue ancestry-correlated binding agent 316 is illustrated generically as “Binding Agent X,” and, similarly, a second example of a generically-referenced treatment agent 320 is illustrated as “Treatment Agent X.” As such, the row 504 illustrates, for example, that two separate instances of the target-related tissue ancestry-correlated binding agent 316 and/or the treatment agent 320 may be associated with, e.g., an instance of either the direct end target 306, and/or with an instance of the target-related tissue ancestry-correlated binding site 314.

The row 506 illustrates another example from the Oh reference. In the row 506, the direct end target 306 is illustrated as “diseased lung tissue,” while the discriminated end target 308 is illustrated as “non-diseased lung tissue.” Thus, the direct intermediate target 310 is illustrated as “endothelial tissue proximate to the diseased lung tissue,” while the discriminated intermediate target 312 is illustrated as “endothelial tissue that is proximate to non-diseased lung tissue.”

Then, the target-related tissue ancestry-correlated binding site 314 is illustrated as fifteen differentially-expressed proteins (e.g., expressed according to the subtractive techniques described herein) associated with the direct intermediate target 310, e.g., the endothelial tissue proximate to the diseased lung tissue. As a result, the target-related tissue ancestry-correlated binding agent 316 is selected and illustrated as I-labeled monoclonal APP antibodies that may be generated for one or more of the fifteen differentially-expressed proteins. As in the row 502, the treatment agent delivery mechanism relative to target-related tissue ancestry-correlated binding agent 318 may involve essentially direct attachment of the treatment agent 320 that is illustrated as radio-immunotherapy via low-levels of radionuclides. In this way, such radionuclides may be concentrated in, and may thereby destroy, tumors. In particular, for example, an identified tumor target was the 34 KDa protein recognized by annexin A1 (AnnA1) antibodies, which was significantly present in substantially only in tumor endothelial plasma membrane.

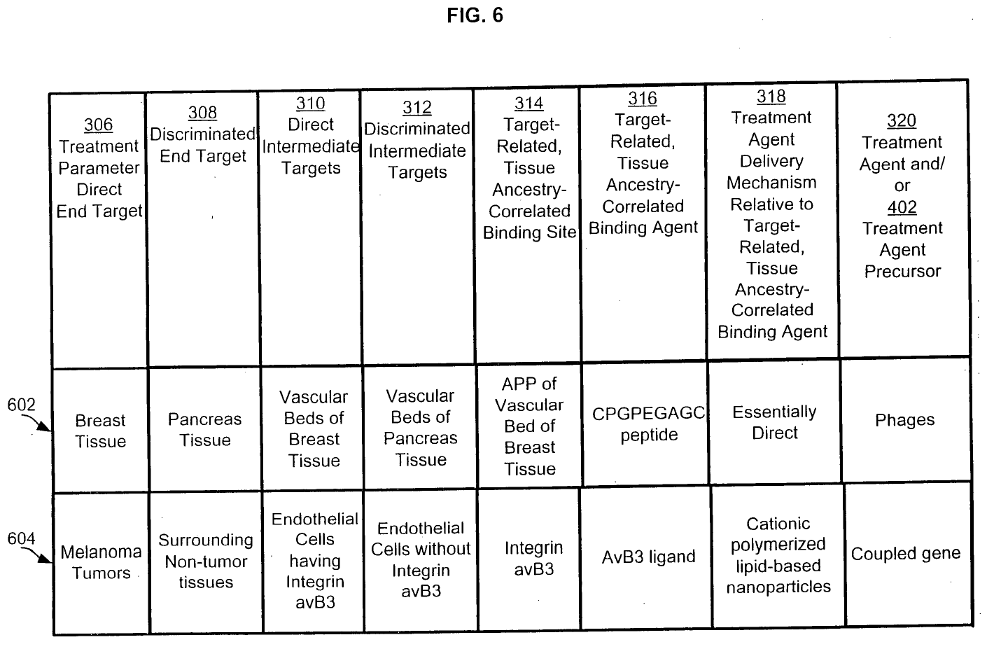

FIG. 6 illustrates additional alternative embodiments of treatment data associated with the clinical system 100 of FIG. 1, with specific examples of treatment data. In FIG. 6, a row 602 illustrates examples that may be found in Essler et al., “Molecular Specialization of Breast Vasculature: A Breast-Homing Phage-Displayed Peptide Binds to Aminopeptidase P in Breast Vasculature,” Proceedings of the National Academy of Sciences, vol. 99, No. 4, pp. 2252-2257 (Feb. 19, 2002), which is hereby incorporated by reference in its entirety, and which may be referred to herein as the Essler reference.

In the Essler reference, a plurality of peptides (e.g., two or more amino acids joined together via a peptide bond) having a general structure of CX7C (where C is cysteine and X is any amino acid) I-labeled monoclonal antibodies were injected into mice. Then tissues of interest were observed to determine a presence of phage(s), and thereby to determine which peptide of the plurality of peptides honed in on the observed tissue(s). In this way, it was determined that the CPGPEGAGC peptide was useful in providing a homing point for phages of the patient's immune system, and, in particular, was useful as a binding agent for the breast tissue, while not binding to pancreas tissue. Although these specific examples of peptides are provided for illustration and explanation, it should be understood that the term peptide as used herein may refer to virtually any lineal peptide-bonded string of amino acid residues, which include various structures thereof, unless context dictates otherwise. For example, a lipopeptide may be interpreted to include virtually all lipoproteins, while glycopeptides may include virtually all glycoproteins.

Thus, in the row 602, the direct end target 306 is illustrated as breast tissue, while the discriminated end target 308 is illustrated as pancreas tissue. The direct intermediate target 310 is illustrated as vascular beds of breast tissue, while the discriminated intermediate target 312 is illustrated as vascular beds of pancreas tissue.

The target-related tissue ancestry-correlated binding site 314 includes a protein, aminopeptidase-P (APP), of the vascular bed of breast tissue. The target-related tissue ancestry-correlated binding agent 316 includes a cyclic nonapeptide known as the CPGPEGAGC peptide, which is shown in the Essler paper to home to the aminopeptidase P receptor. The treatment agent precursor 402 is shown to include phages, which were essentially directly delivered via the CPGPEGAGC peptide to the APP of the vascular bed of breast tissue, and which facilitate attachment of additional/alternative treatment agents 320 to the APP.

A row 604 of FIG. 6 illustrates an example from Hood et al., “Tumor Regression by Targeted Gene Delivery to the Neovasculature,” Science, vol. 296, pp. 2404-2407 (Jun. 28, 2002), which is incorporated by reference in its entirety and which is referred to herein as the Hood reference. The Hood reference refers to the molecule integrin avB3 that plays a role in endothelial cell survival during formation of new blood vessels in a given region, and is preferentially expressed therein. A cationic polymerized lipid-based nanoparticle was synthesized and covalently coupled to a small organic avB3 ligand; that is, the ligand was demonstrated to serve as a binding agent for the integrin avB3 that is preferentially expressed in endothelial cells.

Accordingly, in the row 604, melanoma tumors were used as the direct end target 306, while the discriminated end target 308 is shown as surrounding non-tumor tissues. The direct intermediate target 310 is illustrated as endothelial cells having integrin avB3, while the discriminated intermediate target 312 is shown as endothelial cells without integrin avB3. Thus, the target-related tissue ancestry-correlated binding site 314 is shown to include the integrin avB3, while the target-related tissue ancestry-correlated binding agent 316 is shown to include the avB3 ligand that attaches to the integrin avB3. The treatment agent 320 included a gene selected to disrupt formation of new blood vessels in the tumor(s), which was delivered using the cationic polymerized lipid-based nanoparticle(s), and which thereby deprived the tumor(s) of blood and destroyed the tumor(s).

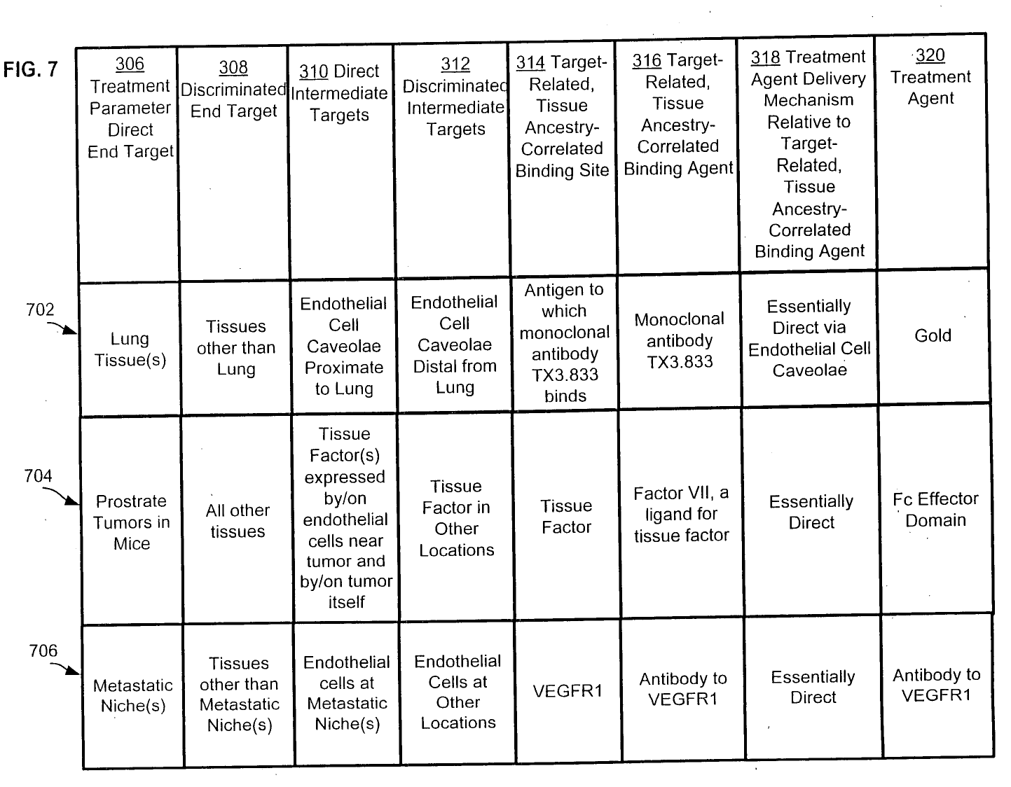

FIG. 7 illustrates additional embodiments of treatment data associated with the clinical system 100 of FIG. 1, with specific examples of treatment data. In a row 702, an example is illustrated from McIntosh et al., “Targeting Endothelium and Its Dynamic Caveolae for Tissue-Specific Transcytosis in vivo: A Pathway to Overcome Cell Barriers to Drug and Gene Delivery,” Proceedings of the National Academy of Sciences, vol. 99, no. 4, pp. 1996-2001 (Feb. 19, 2002), which is hereby incorporated by reference and which may be referred to herein as the McIntosh reference. In the McIntosh reference, endothelial cell plasma membranes from the lungs were analyzed to determine monoclonal antibodies targeted thereto. Additionally, the McIntosh reference illustrated use of the caveolae 124 to allow the treatment agent 320 to cross the endothelium and be delivered directly to lung tissue.

Thus, in the row 702, the direct end target 306 is shown as lung tissue, while the discriminated end target 308 is shown as non-lung tissue. The direct intermediate target 310 is shown as endothelial cell caveolae proximate to the lung tissue, while the discriminated intermediate target 312 is shown as endothelial cell caveolae that is distal from the lung tissue.

The target-related tissue ancestry-correlated binding site 314 is shown as a determined/selected antigen to which the monoclonal antibody TX3.833 binds, so that the target-related tissue ancestry-correlated binding agent 316 is shown as the monoclonal antibody TX3.833 itself. In this way, the treatment agent 320 of gold affixed directly to the TX3.833 antibody was transported over the endothelial plasma membrane into the tissues of interest (e.g., lung tissues); in other words, the caveolae 124 was used to conduct transcytosis.

A row 704 illustrates an example from Zhiwei et al., “Targeting Tissue Factor on Tumor Vascular Endothelial Cells and Tumor Cells for Immunotherapy in Mouse Models of Prostatic Cancer,” Proceedings of the National Academy of Sciences, vol. 98, no. 21, pp. 12180-12185 (Oct. 9, 2001), which is hereby incorporated by reference in its entirety, and which may be referred to as the Zhiwei reference. In the Zhiwei reference, a “tissue factor” is identified as a transmembrane receptor that forms a strong and specific complex with an associated ligand, factor VII (fVII). Such tissue factor, although not normally expressed on endothelial cells, may be expressed on tumor endothelial cells of the tumor vasculature.

Thus, in the example of the row 704, the direct end target 306 includes prostrate tumors, while the discriminated end target 308 includes all other tissues. The direct intermediate target 310 includes tissue factor(s) expressed by/on endothelial cells near the tumor(s) and by/on the tumor itself. The target-related tissue ancestry-correlated binding site 314 includes the tissue factor, while the target-related tissue ancestry-correlated binding site agent 316 includes the factor VII (fVII), the ligand for the tissue factor. In this way, the direct treatment agent 320 of a Fc effector domain was used to provide a marker for an induced immune response.

In a row 706, an example is illustrated from Kaplan et al., “VEGFR1-positive haematopoietic bone marrow progenitors initiate the pre-metastatic niche,” Nature, vol. 438, no. 4, pp. 820-827 (December 2005), which is hereby incorporated by reference and which may be referred to herein as the Kaplan reference. In the Kaplan reference, metastasis is described as a process in which tumor cells mobilize bone-marrow cells to form a site or “pre-metastatic niche” at particular regions (distant from the primary tumor itself), at which the subsequent metastasis may then develop. More specifically, Kaplan describes the idea that cells of a tumor may secrete a molecular/humoral factor(s) that mobilizes bone marrow cells and stimulates fibroblast cells at a distant (future metastatic) site, thereby upregulating fibronectin (a binding, tissue-promoting protein) that serves as a “docking site” for the bone marrow cells. Some of the bone marrow cells were positive for proteins characteristic of haematopoietic progenitor cells, including, for example, vascular endothelial growth factor receptor 1 (VEGFR1), which, in turn, is described as promoting attachment and motility of tumor cells, thereby leading to metastasis. For example, protease production associated with the bone marrow cells may lead to growth factors (e.g., vascular endothelial growth factor (VEGF) that support the developing niche, through, e.g., angiogenesis). In other words, the VEGFR1-positive bone marrow cells serve to form the “pre-metastatic niche” by colonizing a site distant from the tumor, so that subsequently-arriving tumor cells find a hospitable environment at such a site.

Thus, in the example of the row 706, the direct end target 306 may include one-or-more metastatic and/or pre-metastatic niches or sites that are distant from a primary tumor. For example, such niches may be present in the lungs when the primary tumor includes a melanoma. Then, the discriminated end target 308 may include tissues other than these metastatic niches. The direct intermediate target 310 may include endothelial cells at the metastatic niches, while the discriminated intermediate target 312 may include endothelial cells at other locations. Additionally and/or alternatively, the direct intermediate target 310 may include endothelial cellular structures at the metastatic or pre-metastatic niches, while the discriminated intermediate target 312 may include endothelial cellular structures at other locations. In the example of the row 706, the target-related tissue ancestry correlated binding site 314 includes VEGFR1, which, as referenced above, includes a receptor protein on the endothelial cells (to which VEGF may bind). In this case, and as referenced in the Kaplan reference, the target-related tissue ancestry correlated binding agent 316 may include an antibody to VEGFR1, so that the treatment agent delivery mechanism relative to the target-related tissue ancestry correlated binding agent 318 includes an essentially direct delivery of this antibody, where the antibody to VEGFR1 thereby serves as the treatment agent 320 by blocking the VEGFR1 and preventing formation of, occupying, and/or blocking subsequent interactions with development of the pre-metastatic niche. Of course, the row 706 includes merely one example of target-related tissue ancestry correlated binding site(s) and/or target-related tissue ancestry correlated binding agent(s) that may be located within, or in association with, the pre-metastatic niche(s), where appropriate discovery and/or targeting thereof may be performed by any of the techniques described herein, or other techniques. Moreover, it should be understood from the above description that such target-related tissue ancestry correlated binding site(s) and/or target-related tissue ancestry correlated binding agent(s) may be time-dependent, e.g., with respect to formation and metastasis of the primary tumor. Accordingly, application of the just-referenced techniques may be determined and/or occur based on such time-dependencies, e.g., by applying the techniques for patients at high risk of metastatic disease, but for whom metastatic disease has not yet actualized in the form of established metastases.

In other, related, examples, the treatment(s) just described (e.g., use of an antibody to VEGFR1) should be understood to represent merely an example(s) of how to reduce or eliminate development of the pre-metastatic niche(s) and/or metastasis of the primary tumor. For example, molecular addressing as described herein may be used to slow or stop the upregulation of fibronectin. In such examples, and considering the time-dependent nature of metastasis and treatment just referenced, the alternative treatment modalities (e.g., regulating a presence or development of VEGFR1 and fibronectin) may be seen as complementary to one another. For example, such treatment modalities may be implemented cyclically for the patient 106, the better to disrupt the pre-metastatic/metastatic pathway as a whole, and thereby to increase an efficacy of the overall treatment of the patient 106. Of course, similar comments apply to treatment modalities applied at other points in the pathway, as well as to other pathways, as would be apparent.

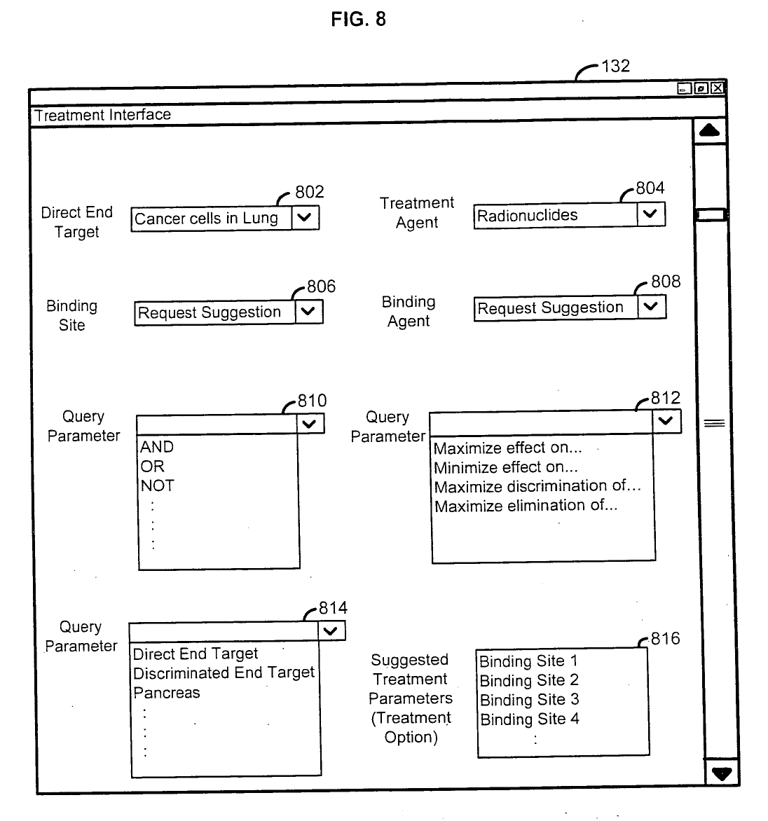

FIG. 8 illustrates an example screenshot of a graphical user interface for search techniques related to tissue coding. In the example of FIG. 8, the user interface 132 includes a plurality of fields 802, 804, 806, 808, 810, 812, 814, and 816. In some implementations, the fields 802-816 allow the clinician 104, or other user(s), to access, analyze, or otherwise consider or use the treatment data 126 of FIG. 1 to diagnose and/or treat the patient 106. For example, as referenced herein, the clinician 104 may determine Or consider treatment options to select and deliver an appropriate type and/or level of a treatment agent, with an appropriate degree of accuracy, to a desired (direct) end target, while minimizing a negative impact of such a selection/delivery, if any, on other regions of the body of the patient 106. In some implementations, for example, the user interface 132 thus provides the clinician 104 with treatment options that the clinician 104 may use, for example, when formulating a treatment action or research plan.

For example, the field 802 may include a drop-down menu by which the clinician 104 may select a direct end target that is desired for treatment or analysis. In the example of FIG. 8, the field 802 is illustrated as showing a selection of “cancer cells in lung” as the direct end target. Meanwhile, the field 804 illustrates a selection of “radionuclides” as a potential treatment agent.

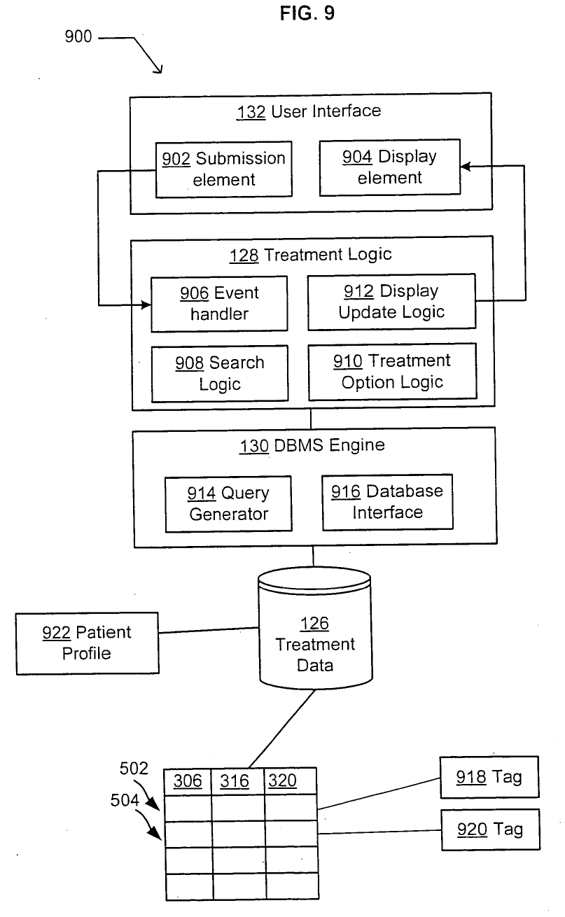

As described herein, delivery of radionuclides or other appropriate treatment agents to a desired bodily location may be accomplished by using a “molecular address” provided by a target-related tissue ancestry-correlated binding site, e.g., by associating the treatment agent (radionuclides) with a target-related tissue ancestry-correlated binding agent that is known to deliver the treatment agent to the target-related tissue ancestry-correlated binding site (and thereby, for example, to surrounding target tissue), while discriminating against, or avoiding, ancillary or undesired delivery of the treatment agent to non-target tissue(s). Thus, in the example of FIG. 8, once the clinician 104 selects a desired direct end target using the field 802, and a desired treatment agent in the field 804, then the clinician 104 may select “request suggestion” in one or both of the fields 806, 808 associated with a target-related tissue ancestry-correlated binding site and/or a target-related tissue ancestry-correlated binding agent, respectively, as shown. In this case, the system 100 or similar system (e.g., the system 900 of FIG. 9, discussed in more detail, below) may thus provide, for example, a suggestion for the target-related tissue ancestry-correlated binding agent of “I labeled monoclonal antibodies,” for consideration and possible use by the clinician 104 in applying the treatment agent (radionuclides) of the field 804 to the direct end target (cancer cells in lung) of the field 802. Of course, in other examples, the clinician 104 may request a suggestion for the direct end target in the field 802, or may request a suggestion for the treatment agent in the field 804.

It should be understood that although the present description is primarily provided with respect to the clinician 104 and/or the patient 106, such examples are provided merely for the sake of illustration, and are not limiting. For example, the user interface 132, or virtually any other element or feature described herein, may be used, depending on context, by virtually any user who is authorized to do so. For example, certain medical procedures/treatments may be restricted by law only to licensed, authorized physicians. Nonetheless, other implementations of the user interface 132 may be used by virtually any user. For example, the user interface 132 may be used in association with a use of vitamins, nutrients, or other beneficial substances that are not government-regulated or otherwise restricted. Therefore, users may access the user interface 132, perhaps over the Internet, in order to obtain a highly-personalized and effective self-treatment for, for example, delivering nutrients to desired body locations or systems. Thus, although the present description is primarily provided with respect to clinical settings, it should be understood that aspects of the present description should be considered to apply to any medical, medicinal, therapeutic, remedial, curative, corrective, or otherwise health-related setting, situation, or context.

In the example of FIG. 8, additional fields 810, 812, and 814 allow the clinician 104 to associate one or more additional query parameters with a request for a treatment option, e.g., with a request for a target-related tissue ancestry-correlated binding site and/or a target-related tissue ancestry-correlated binding agent. For example, the field 810 allows the clinician 104 to select a Boolean operator as a query parameter, so that the request for a treatment option may be refined or specified. In FIG. 8, the Boolean operator(s) of the field 810 may operate on a query parameter(s) from the fields 812 and/or 814, or, more generally, may operate on any of the values or aspects of the fields 802-808, 812, and/or 814.

For instance, the clinician 104 may specify a request for a target-related tissue ancestry-correlated binding site, and at the same time may specify in the request that the treatment option to be provided is desired to maximize or minimize an effect (as specified in the field 812) on the direct end target or the discriminated end target (as specified in the field 814). That is, for example, the clinician 104 may formulate or input a request that may be stated as “provide a treatment option using a target-related tissue ancestry-correlated binding site AND minimizing an effect on an associated discriminated end target.” For example, such a request (and resulting treatment option) may occur when the treatment agent is harmful to certain discriminated end targets, and/or when the patient 106 has a discriminated end target (e.g., liver or pancreas) that is particularly vulnerable to the treatment agent (e.g., due to a pre-existing condition of the patient 106). Of course, the same or similar requests for treatment options may be formulated somewhat differently. For example, the clinician 104 may specify a desire for a maximized discrimination of the pancreas, using the fields 810-814.

As a result, the field 816 may be used to provide treatment option(s), which, in the example of FIG. 8, includes one or more target-related tissue ancestry-correlated binding sites. In some implementations, the treatment options may be provided in a list, and the list (e.g., here, the target-related tissue ancestry-correlated binding sites) may be ranked according to the criteria specified in the fields 810-814. For example, the first-listed target-related tissue ancestry-correlated binding site may be most effective in accurately delivering the treatment agent to the direct end target, when such a criteria is specified in the fields 810, 812, and/or 814. In some implementations, such a ranked list also may be thresholded, so that, for example, provided examples of target-related tissue ancestry-correlated binding sites may be removed when judged to fall below a certain level of efficacy, and/or when a maximum number of target-related tissue ancestry-correlated binding sites has been reached. As should be apparent, although not explicitly illustrated in FIG. 8, additional or alternative fields to the fields 810-814 may be used to specify desired criteria for such ranking and/or thresholding.

Although FIG. 8 illustrates the use of drop-down menus in requesting treatment options, it should be understood that virtually any technique may be used to request such a treatment option. For example, the clinician 104 may simply be allowed to enter a text query or search into one or more text-input fields. As another example, a graphical illustration, e.g., of a human body, may be provided, and the clinician 104 may select body portions associated with the treatment option (and thereafter view a possible result or implication of the treatment option) with reference to the graphical illustration. As yet another example, the user interface 132 may present the clinician 104 with a series of questions, perhaps posed using consecutively-presented pop-up screens, so that the treatment logic 128 may narrow possible treatment options, based on earlier answers/input from the clinician 104.

Thus, in some example implementations, the clinician 104 need not be directly involved in structuring a query (e.g., of the treatment data 126) associated with obtaining the treatment option. That is, for example, the clinician 104 need not select an appropriate Boolean operator, but, rather, may simply specify a desired health-related effect in a specified context (e.g., with specified parameters), and the treatment logic 128 may then formulate an appropriate query of the treatment data 126. Similarly, then, the clinician 104 need not explicitly reference, obtain, or even be aware of, a target-related tissue ancestry-correlated binding site and/or target-related tissue ancestry-correlated binding agent when requesting a treatment option. Instead, for example, the treatment logic 128 may determine an appropriate target-related tissue ancestry-correlated binding site and/or target-related tissue ancestry-correlated binding agent, based on the request for the treatment option, and may then provide the treatment option based thereon.

FIG. 9 illustrates an alternative embodiment of the clinical system of FIG. 1 in which the clinical system is configured to provide search techniques related to tissue coding. Thus, FIG. 9 illustrates examples by which the user interface 132 may be used to search the treatment data 126, in order to provide, for example, the treatment option(s) described above with respect to FIG. 8.

In the example of FIG. 9, the user interface 132 is illustrated as containing generic elements 902 and 904, e.g., a submission element 902 and a display element 904. Generally, the submission element 902 may include any icon, button, field, menu, screen, or box that may be used by the clinician 104 to select, submit, or request information. The display element 904 may include any element of the user interface 132 used to provide information to the clinician 104, where it should be understood that in some cases the submission element 902 and the display element 904 may include the same element, or related elements, since, for example, the clinician 104 may enter or select data using a given element and then may view the results of the entry or selection using the same element. Thus, and as should be apparent from FIG. 8, the submission element 902 may include, for example, any of the fields 802- 814. Meanwhile, any of the fields 802-816 may be considered to be an example of the display element 904, since any of these may be used to display information (e.g., a suggested treatment option, or an aspect thereof).

Thus, for example and as described herein, the clinician 104 may utilize the submission element(s) 902 to submit a request for a treatment option, the request associated with one or more query parameters. For example, when the clinician 104 uses the fields 802 and 804 to specify a direct end target and a treatment agent, respectively, then this submission is passed to the treatment logic 128, or, more specifically, is passed to an event handler 906 that receives the submission and performs an initial classification, logging, routing, or other handling of the type and value of the submission event, e.g., here, the type including a request for a treatment option that specifies a target-related tissue ancestry-correlated binding site and/or a target-related tissue ancestry-correlated binding agent.

For example, a submission event (e.g., request for a treatment option) associated with a use of the submission element 902 by the clinician 104 may be passed by the event handler 906 to search logic 908 and/or treatment option logic 910. As described in more detail herein, the search logic 908 may be used to formulate a query of the treatment data 126, based on the request and associated query parameter(s). Thus, for example, a target-related tissue ancestry-correlated binding site and/or a target-related tissue ancestry-correlated binding agent may be determined from the treatment data 126. Based on the query parameter(s) and the target-related tissue ancestry-correlated binding site and/or the target-related tissue ancestry-correlated binding agent, the treatment option logic 910 may determine one or more treatment options, and may rank and/or threshold the treatment options according to a specified manner (e.g., specified in the request). Further, the treatment option logic 910 may operate in conjunction with display update logic 912 to update the display element 904 appropriately in providing the treatment options. For example, the treatment option logic 910 may communicate with the display update logic 912 to construct a graphical illustration, e.g., of a human body, that illustrates possible effects of the provided treatment options.

In operation, for example, the search logic 908 may interact with a query generator 914 of the DBMS engine 130 to generate a query that may be passed by a database interface 916 to the treatment data 126. In this and other examples, then, the treatment logic 128 may interact with the DBMS engine 130 to construct a query and pass the query to the treatment data 126. For instance, a query may be built that includes a Boolean combination of a first query parameter specifying a maximum effect of the treatment agent on the direct end target OR a second query parameter specifying a maximally efficient elimination of the treatment agent, where the query may be generated with a form and structure that is appropriate for the treatment data 126 (e.g., using the Structured Query Language (SQL) in a case where the treatment data 126 implements a relational database).

In FIG. 9, example data results and/or datasets are referenced to FIG. 5, where, as shown in FIG. 5, rows 502 and 504 include (abbreviated) data results for a direct end target 306, a target-related, tissue ancestry-correlated binding agent 316, and a treatment agent 320. In this case, for example, data from the row 502 may be associated with a tag 918 indicating that data from the row 502 is associated with maximum effect of the treatment agent on an associated direct end target, while data from the row 504 may be associated with a tag 920 indicating that data from the row 504 is associated with maximally-efficient elimination of the treatment agent (where such examples are intended to illustrate a use of the tags 918, 920 with respect to a query from the DBMS engine 130, and are not intended, necessarily, with specific reference to the Oh reference of FIG. 5). In some implementations, for example, the tags 918 and 920 may be associated with use of the eXtensible Markup Language (XML) in constructing the treatment data 126, where use of XML or other semi-structured databases is discussed in more detail, herein. In this case, then, the database interface 916 may include an XML interface.

It should be understood, then, that the tags 918, 920 may be used in generating and executing queries against the treatment data 126 by the search logic 908. For example, the search logic 908 may interact with the query generator 914 to generate a query against the treatment data 126, using the tags 918, 920 to identify,, and thereby remove/exclude, data that matches one or more of the query parameters of the fields 810-814.

In some example implementations, the treatment data 126 may be associated with a patient profile 922. The patient profile 922 may include, for example, a medical history of the patient 106, a family medical history of the patient 106, or a current drug/medication usage of the patient 106. In this way, treatment options may be provided in an accurate and highly-personalized manner, while minimizing an amount of personalized information required to be known by the clinician 104. For example, the clinician 104 may specify, as part of a request for a treatment option, a query parameter that should only be used (or should NOT be used) if the patient 106 is known to have certain characteristics (e.g., a weakened liver, or a particular allergy). For example, the clinician 104 may specify, in association with the request for a treatment option, that certain treatment agents should be ranked highly if the patient 106 has a weakened immune system. Then, the search logic 908 may access the patient profile 922 to determine whether the patient 106 has a certain number or type of characteristics associated with a weakened immune system, and may query the treatment data 126 accordingly.

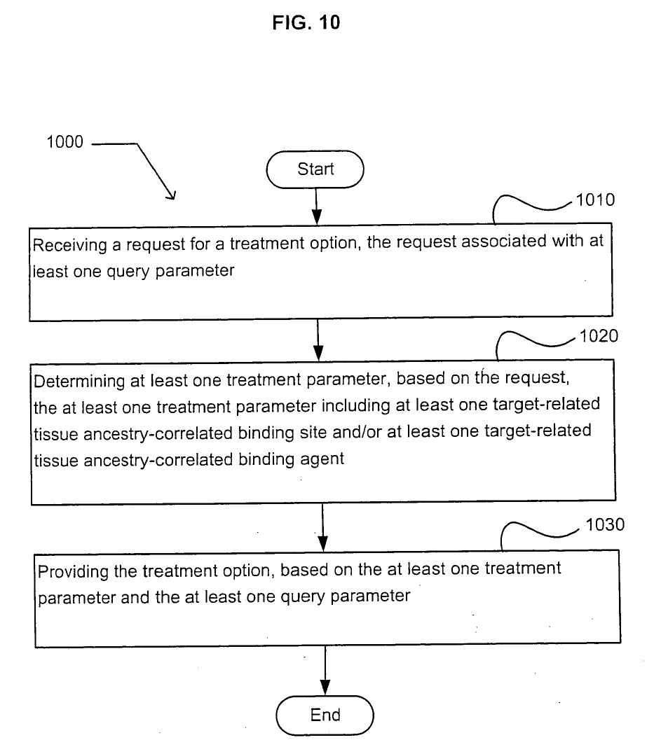

FIG. 10 illustrates an operational flow representing example operations related to search techniques related to tissue coding. In FIG. 10 and in following figures that include various examples of operational flows, discussion and explanation may be provided with respect to the above-described examples of FIGS. 1-9, and/or with respect to other examples and contexts. However, it should be understood that the operational flows may be executed in a number of other environments and contexts, and/or in modified versions of FIGS. 1-9. Also, although the various operational flows are presented in the sequence(s) illustrated, it should be understood that the various operations may be performed in other orders than those which are illustrated, or may be performed concurrently.

After a start operation, the operational flow 1000 moves to a receiving operation 1010 where a request for a treatment option is received, the request associated with at least one query parameter. For example, as shown in FIG. 8, the user interface 132 may be used to receive a request for a treatment option that includes, or is otherwise based on or associated with, a target-related tissue ancestry-correlated binding site and/or a target-related tissue ancestry-correlated binding agent. A query parameter, such as a Boolean operator and/or an operand, may be associated with the request, e.g., using one or more of the fields 810-814, or similar fields.

Then, in a determining operation 1020, at least one treatment parameter may be determined, based on the request, the at least one treatment parameter including at least one target-related tissue ancestry-correlated binding site and/or at least one target-related tissue ancestry-correlated binding agent. For example, the treatment parameter may be included in, or otherwise associated with, the request, e.g., using the field(s) 806 and/or 808. In other examples, the search logic 908 may determine the at least one treatment parameter, based on the query parameter(s). For example, as described herein, the query parameter may specify a desired efficacy of the treatment agent on a direct end target (e.g., on “cancer cells in lung,” as may be specified in the field 802), and/or a risk, side effect, or consequence of the treatment agent on the at least one direct end target, or on at least one other body portion (e.g., the pancreas 110). Thus, in this example, the search logic 908 may determine appropriate treatment parameter(s) from the treatment data 126, based on the query parameter.

Although examples of such query parameters are provided herein, it should be generally understood that such query parameter(s) may include virtually any diagnostic, symptomatic, screening, preventative, and/or research parameter(s) that may be correlated, e.g., in the treatment data 126 and/or by the treatment logic 128, with the treatment parameter(s). As a result, for example, and as described herein, the clinician 104 may specify such a query parameter using the user interface 132, and may thereafter be provided with a suggested treatment option(s) (and/or possible outcome thereof), without having to specify (or otherwise have knowledge of)-treatment parameter(s) such as the target-related tissue ancestry-correlated binding site and/or the target-related tissue ancestry-correlated binding agent.

As a more specific example of query parameter(s) just referenced, an inflammation marker may be used to diagnose or recognize an increased risk of certain diseases (e.g., heart disease). Such parameters, in a diagnostic setting, may lead to a diagnosis indicating use of a corresponding treatment parameter(s) to achieve a desired effect (e.g., a corresponding anti-inflammatory treatment agent, which may be delivered to an appropriate bodily location(s) by way of appropriate target-related tissue ancestry-correlated binding site(s), associated target-related tissue ancestry-correlated binding agent(s), and/or treatment agent(s)). In other words, for example, the treatment system 102 may determine the at least one treatment parameter based on the at least one associated query parameter (e.g., the inflammation marker, which may be received from the clinician 104 through the user interface 132).

Thus, for example, it should be understood that the user interface 132 and/or the treatment system 102 may be used by the clinician 104 with little or no external reference to the treatment parameters/treatment characteristics 302-320 of FIGS. 3-7 being visible to, or directly used by, the clinician 104. For example, the user interface 132 may present (and/or allow the clinician 104 to specify) a particular illness, and corresponding (suggested) medical procedure(s), where such illness(es) and procedures may be related/applicable to one another through application of, for example, appropriately-selected target-related tissue ancestry-correlated binding site(s) and target-related tissue ancestry-correlated binding agent(s). In such cases, then, the treatment system 102 acts transparently, so that the clinician 104 need not consider, or even be aware of, these particular mechanisms underlying the suggested procedure(s), and, instead, may simply be provided by the user interface 132 with a suggested treatment option (and indicated efficacy thereof) for a specified illness.

Thus, in a providing operation 1030, the treatment option may be provided, based on the at least one treatment parameter and the at least one query parameter. For example, the treatment option logic 910 may provide the treatment option as including the at least one treatment parameter(s), or as being based on the at least one treatment parameter(s). As described herein, the treatment option logic 910 may provide the treatment option by way of the user interface 132 (e.g., using the display update logic 912), and also may determine whether and how to rank, threshold, illustrate, or otherwise present the treatment option(s). As a result, for example, the clinician 104 may be provided with a fast, accurate, and up-to-date recommendation or suggestion for one or more treatment options, for appropriate use in a desired clinical, diagnostic, research, or other health-related setting.

The operation(s) 1010-1030 may be performed with respect to a digital representation (e.g., as digital data), for example, of the treatment parameter(s) and/or the treatment option(s). For example, as may be understood with reference to FIGS. 8 and 9, the treatment logic 128 may accept a digital or analog (for conversion into digital) representation of the request for a treatment option from the user interface 132 (e.g., from the submission element 902), for presentation to the DBMS engine 130 and/or the treatment data 126. As another example, the treatment logic 128 may provide a digitally-encoded representation of the treatment option, based on the treatment data 126, where the treatment data 126 may be implemented and accessed locally, and/or may be implemented and accessed remotely.

Thus, an operation(s) may be performed related either to a local or remote storage of the digital data, or to another type of transmission of the digital data. As discussed herein, in addition to accessing, querying, recalling, determining or otherwise obtaining the digital data for the providing operation 1030 (e.g., digital data output as a result of the providing operation 1030), operations may be performed related to storing, assigning, associating, or otherwise archiving the digital data to a memory, including, for example, sending and/or receiving a transmission of the digital data from a remote memory. Accordingly, any such operation(s) may involve elements including at least an operator (e.g., either human or computer) directing the operation, a transmitting computer, and/or a receiving computer, and should be understood to occur within the United States as long as at least one of these elements resides in the United States.

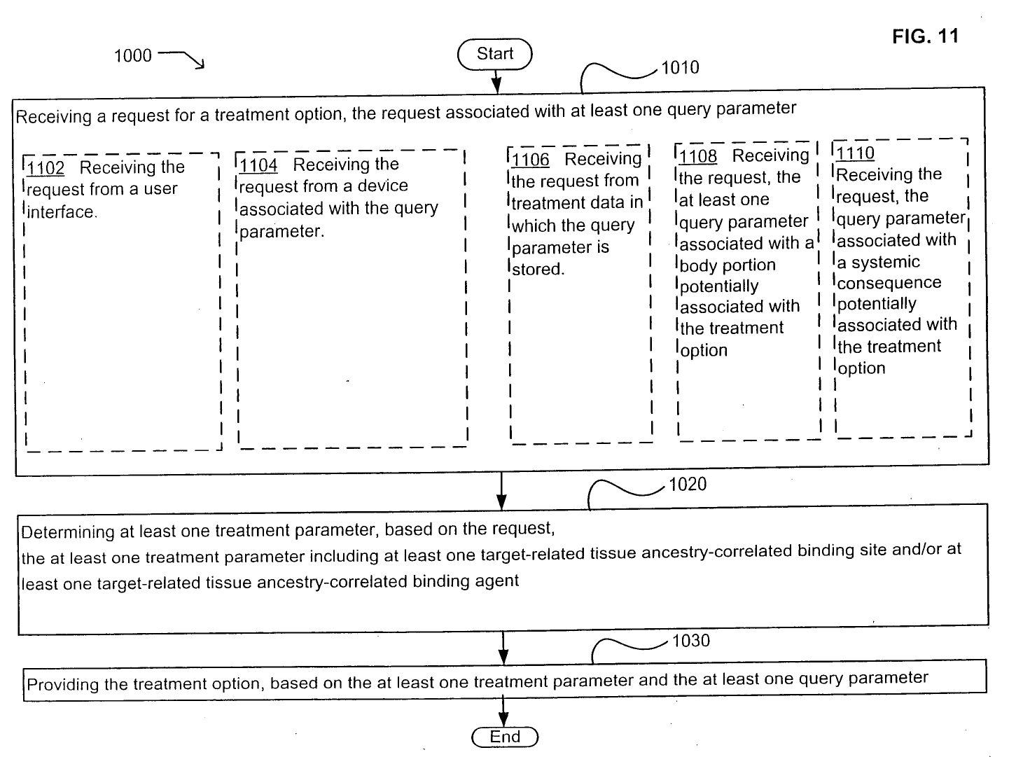

FIG. 11 illustrates alternative embodiments of the example operational flow 1000 of FIG. 10. FIG. 11 illustrates example embodiments where the receiving operation 1010 may include at least one additional operation. Additional operations may include an operation 1102, an operation 1104, an operation 1106, an operation 1108, and/or an operation 1110.

At the operation 1102, the request may be received from a user interface. For example, the request may be received from the user interface 132, after entry therein by the clinician 104. In a more specific example, the request (and associated query parameter(s)) may be received using the submission element 902 of the user interface 132, e.g., one or more of the fields 802-814.

At the operation 1104, the request may be received from a device associated with the query parameter. For example, the clinician device 134 may include a monitoring device that is operable to monitor the patient 106 (e.g., to monitor a blood pressure, temperature, or blood oxygen level of the patient 106). Thus, for example, the query parameter may include the blood oxygen level of the patient 106, as determined by the clinician device 134, which may thus output or otherwise provide the query parameter to the treatment system 102 (e.g., automatically, in response to the patient 106 reaching a pre-determined blood oxygen level). In this way, determination of the treatment parameter(s) and/or the treatment option(s) may be made in a timely and accurate manner, with little or no involvement of the clinician 104 in inputting values or characteristics of the query parameter(s). For example, a particular treatment parameter may be determined as having a minimal effect on a blood oxygen level of the patient 106.

At the operation 1106, the request may be received from treatment data in which the query parameter is stored. For example, the treatment logic 128 may obtain the request and the query parameter from the treatment data 126, which may include the patient profile 922. For example, the patient profile 922 may include, or be associated with, instructions to the treatment system 102 to determine a treatment option for the patient 106 at a pre-determined time (e.g., every day), or in response to a pre-determined event (e.g., in response to an updating of the patient profile 922). Accordingly, the treatment logic 128 may receive the request from, or in association with, the patient profile 922, and thus may ultimately provide the treatment option based on the query parameter as stored in the patient profile 922.

At the operation 1108, the request may be received, the at least one query parameter being associated with a body portion potentially associated with the treatment option. For example, as shown in FIG. 8, the query parameter may include a body portion potentially associated with the treatment option, such as the direct end target “cancer cells in lung,” as specified in the field 802, with an additional query parameter specified in the field 812 that an efficacy of the treatment agent of the field 804 should be maximized (e.g., even if side effects are increased).

At the operation 1110, the request may be received, the query parameter associated with a systemic consequence potentially associated with the treatment option. For example, the query parameter may be associated with a blood pressure, temperature, blood oxygen level, nervous system, or lymphatic system of the patient 106. Thus, the request may be associated with such systemic consequences, and the treatment option may be associated with a desired effect thereon (e.g., lowering blood pressure or temperature).

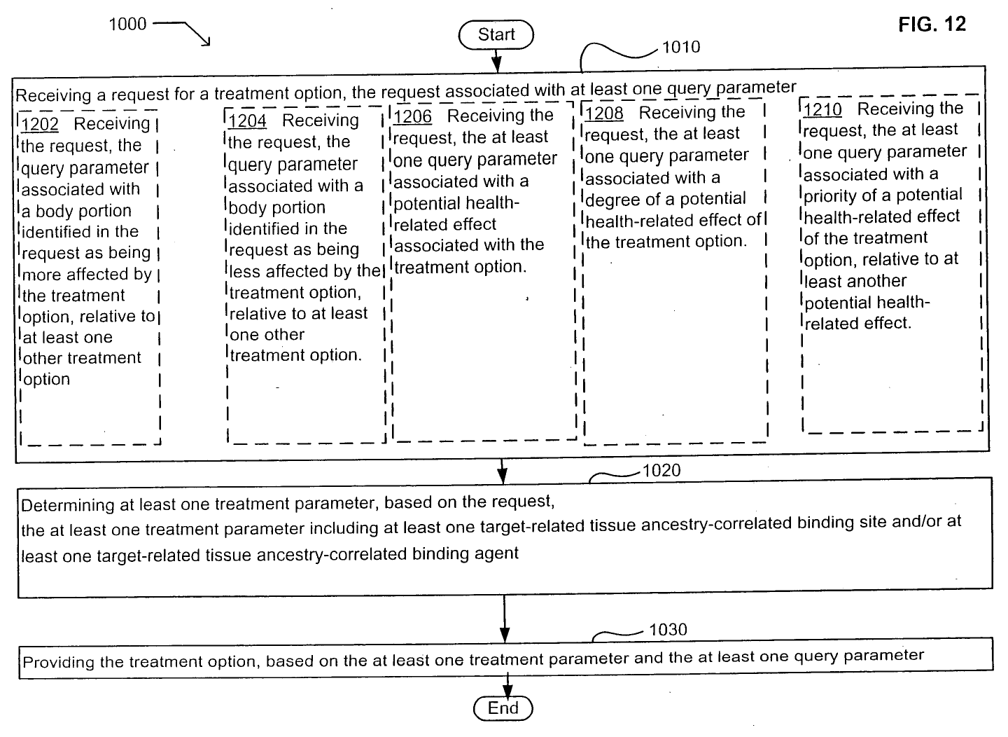

FIG. 12 illustrates alternative embodiments of the example operational flow 1000 of FIG. 10. FIG. 12 illustrates example embodiments where the receiving operation 1010 may include at least one additional operation. Additional operations may include an operation 1202, an operation 1204, an operation 1206, an operation 1208, and/or an operation 1210.

At the operation 1202, the request may be received, the query parameter associated with a body portion identified in the request as being more affected by the treatment option, relative to at least one other treatment option. For example, the request may be received from the user interface 132, and the query parameter “direct end target” may be associated with the body portion “cancer cells in lung,” as shown in the field 802. In this case, the request may identify that the body portion “cancer cells in lung” may be more affected by the treatment option (e.g., application of the treatment agent cradionuclides” using “binding site 1” specified in the field 816), relative to at least one other treatment option (e.g., application of the treatment agent “radionuclides” using “binding site 2” specified in the field 816). Thus, the clinician 104 may request, and receive, a range of treatment options, ordered with respect to their relative efficacies.

At the operation 1204, the request may be received, the query parameter associated with a body portion identified in the request as being less affected by the treatment option, relative to at least one other treatment option. For example, the request may be received from the user interface 132, and a query parameter for a “discriminated end target” may be associated with the body portion “non-cancer cells in lung.” In this case, the request may identify that the body portion “non-cancer cells in lung” may be less affected by the treatment option (e.g., application of the treatment agent “radionuclides” using “binding site 1” specified in the field 816), relative to at least one other treatment option (e.g., application of the treatment agent “radionuclides” using “binding site 2” specified in the field 816). Thus, the clinician 104 may request, and receive, a range of treatment options, ordered with respect to their relative ability to discriminate between affected and non-affected targets, so that, for example, the clinician 104 may minimize an effect of the treatment agent on body portions that are desired not to be affected thereby.

At the operation 1206, the request may be received, the at least one query parameter associated with a potential health-related effect associated with the treatment option. For example, the query parameter may include “reduction or eradication of cancer cells in lung,” in which case a resulting treatment option may be associated with the health-related effect of cancer removal/remission for the patient 106. Of course, virtually any other health-related effect may be obtained or associated with the treatment option, such as, for example, improvement of an immune system of the patient 106, provision of a particular nutrient to the patient 106, or provision of an imaging agent to a desired bodily region of the patient 106.

At the operation 1208, the request may be received, the at least one query parameter associated with a degree of a potential health-related effect of the treatment option. For example, a degree of eradication of “cancer cells in lung” desired in the treatment option may be associated with the query parameter. Similarly, and again continuing the examples just given, a degree to which the immune system is improved, or to which the nutrient provided (e.g., absorbed), also may be specified by the query parameter. In this regard, the degree of the potential health-related effect may be assigned or associated with results, data, or datasets within the treatment data 126, prior to a use of the user interface 132 by the clinician 104, using, e.g., the tags 918 and 920, or similar techniques. Accordingly, one skilled in the art would appreciate that no subjectivity is involved in providing the treatment option(s) in association with relative degrees of associated health-related effects.

At the operation 1210, the request may be received, the at least one query parameter associated with a priority of a potential health-related effect of the treatment option, relative to at least another potential health-related effect. For example, a treatment option may be associated with multiple health-related effects, where some of the health-related effects may be beneficial, and others may be detrimental. In such cases, for example, the query parameter may specify which of the beneficial health-related effects is/are more important or more desired for a particular treatment option and patient. Conversely, the query parameter may specify which of the detrimental health-related effects is/are more important or more desired to be avoided for a particular treatment option and patient.

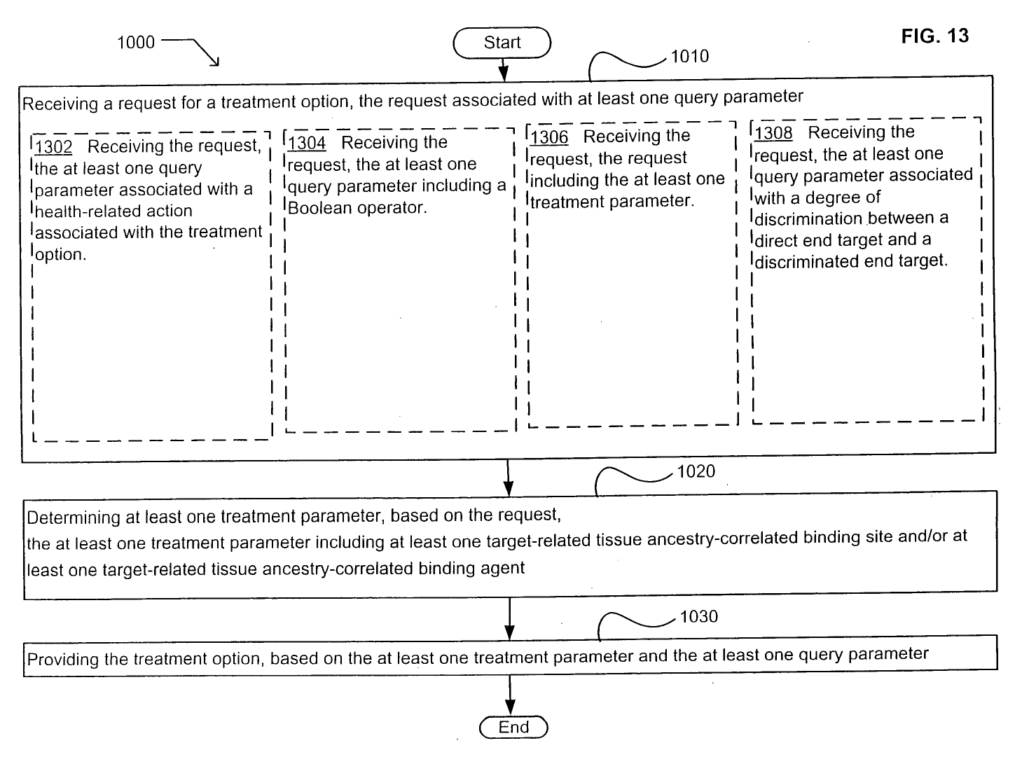

FIG. 13 illustrates alternative embodiments of the example operational flow 1000 of FIG. 10. FIG. 13 illustrates example embodiments where the accessing operation 1010 may include at least one additional operation. Additional operations may include an operation 1302, an operation 1304, an operation 1306, and/or an operation 1308.

At the operation 1302 the request may be received, the at least one query parameter associated with a health-related action associated with the treatment option. For example, the user interface 132 may be used to specify that the treatment option is desired to include a particular type of administration of the treatment agent (e.g., intravenously, or in pill form). As should be apparent, such information may be relevant to the search logic 908 and/or the treatment logic 910 in determining a particular treatment option, since, for example, a particular target-related tissue ancestry-correlated binding agent may be more amenable/suitable for use with one health-related action than another.

At the operation 1304 the request may be received, the at least one query parameter including a Boolean operator. For example, as shown in FIG. 8, the field 810 may be used to specify a Boolean operator, such as, for example, “AND,” “OR,” “NOT,” or “XOR.” Thus, various permutations and combinations of the treatment parameter(s) and/or query parameters may be specified, so that the treatment option may be provided, for example, in a manner that closely matches a need or expectation of the clinician 104, and/or that provides a highly-personalized and highly-effective treatment option for the patient 106. In some implementations, the search logic 908 may execute a query of the treatment data 126, based on the Boolean operator, to determine the treatment option.

At the operation 1306, the request may be received, the request including the at least one treatment parameter. For example, the user interface 132 may be used to submit a request that includes the direct end target in the field 802, the treatment agent in the field 804, and a particular target-related tissue ancestry-correlated binding site in the field 806. Then, the search logic 908 and/or the treatment option logic 910 may be used to provide the treatment option as including the target-related tissue ancestry-correlated binding agent. As another example, the user interface 132 may be used to submit a request that includes the direct end target in the field 802, a particular target-related tissue ancestry-correlated binding site in the field 806, and a particular target-related tissue ancestry-correlated binding agent in the field 808, and may request a treatment option that includes suggestions for the treatment agent, to be supplied in the field 810. Then, the search logic 908 and/or the treatment option logic 910 may be used to provide the treatment option as including the treatment agent.

At the operation 1308, the request may be received, the at least one query parameter associated with a degree of discrimination between a direct end target and a discriminated end target. For example, the direct end target “cancer cells in lung” may be specified in the field 802, while a discriminated end target “non-cancer cells in lung” may be specified elsewhere in the user interface 132 (e.g., in a field not explicitly shown in the example of FIG. 8). Then, the query parameter associated with the request may be used to specify that a high degree of discrimination is desired between the direct end target and the discriminated end target, so that, for example, a minimal amount of radionuclides are delivered to the discriminated end target. In other words, for example, the search logic 908 may search for a treatment option (e.g., including a specific instance(s) of a target-related tissue ancestry-correlated binding site and/or a target-related tissue ancestry-correlated binding agent that is/are known (e.g., as indicated by the tags 918, 920) to have a high degree of discrimination between the direct end target and the discriminated end target. Then, the treatment option logic 910 may order or rank the results based on the relative degree(s) of discrimination.

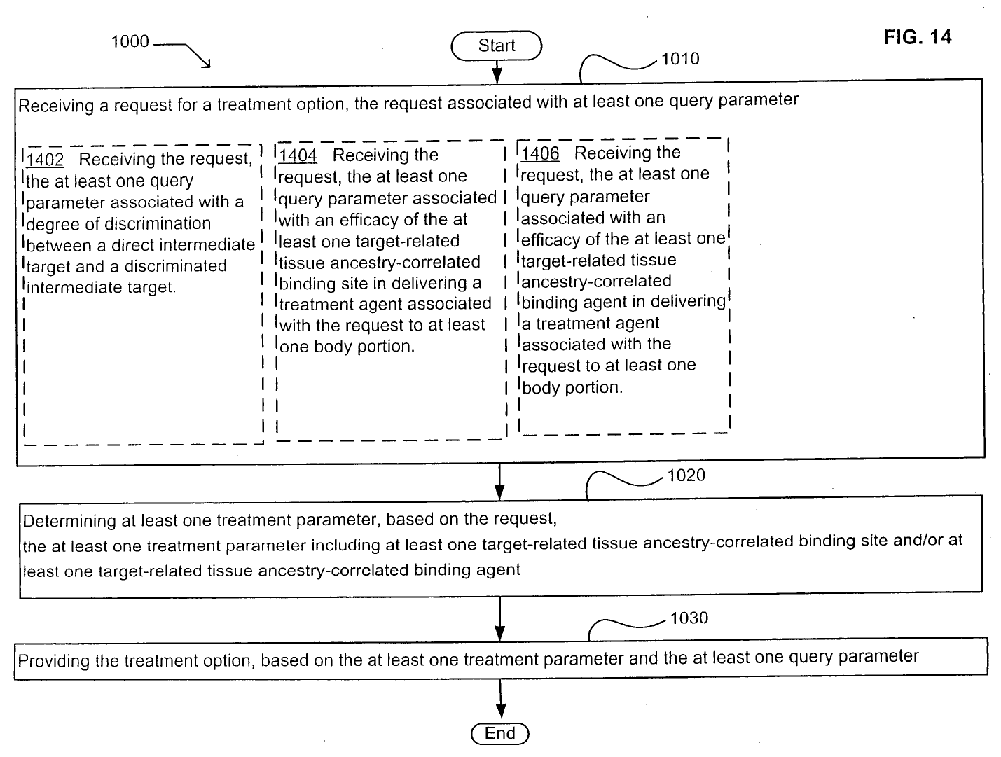

FIG. 14 illustrates alternative embodiments of the example operational flow 1000 of FIG. 10. FIG. 14 illustrates example embodiments where the receiving operation 1010 may include at least one additional operation. Additional operations may include an operation 1402, an operation 1404, and/or an operation 1406.

At the operation 1402, the request may be received, the at least one query parameter associated with a degree of discrimination between a direct intermediate target and a discriminated intermediate target. For example, the user interface 132 may be used to specify a direct intermediate target, such as, for example, endothelial tissue proximate to diseased lung tissue, as well as a discriminated intermediate target, such as, for example, endothelial tissue proximate to non-diseased lung tissue. Then, the query parameter associated with the request may be used to specify that a high degree of discrimination is desired between the direct intermediate target and the discriminated intermediate target, so that, for example, a minimal amount of radionuclides are delivered to the discriminated intermediate target. In other words, for example, the search logic 908 may search for a treatment option (e.g., including a specific instance(s) of a target-related tissue ancestry-correlated binding site and/or a target-related tissue ancestry-correlated binding agent that is/are known (e.g., as indicated by the tags 918, 920) to have a high degree of discrimination between the direct intermediate target and the discriminated intermediate target. Then, the treatment option logic 910 may order or rank the results based on the relative degree(s) of discrimination.

At the operation 1404, the request may be received, the at least one query parameter associated with an efficacy of the at least one target-related tissue ancestry-correlated binding site in delivering a treatment agent associated with the request to at least one body portion. For example, the user interface 132 may be used to provide the query parameter as specifying a certain level of efficacy of the target-related tissue ancestry-correlated binding site, below which examples of target-related tissue ancestry-correlated binding site(s) should not be returned/included in the treatment option. As another example, the user interface 132 may be used to provide the query parameter as specifying a certain level of efficacy of the target-related tissue ancestry-correlated binding site, relative to additional effects of the use of the target-related tissue ancestry-correlated binding site (e.g., relative to a degree of discrimination provided by the target-related tissue ancestry-correlated binding site(s)).

At the operation 1406 the request may be received, the at least one query parameter associated with an efficacy of the at least one target-related tissue ancestry-correlated binding agent in delivering a treatment agent associated with the request to at least one body portion. For example, the user interface 132 may be used to provide the query parameter as specifying a certain level of efficacy of the target-related tissue ancestry-correlated binding agent, below which examples of target-related tissue ancestry-correlated binding agent (s) should not be returned/included in the treatment option. As another example, the user interface 132 may be used to provide the query parameter as specifying a certain level of efficacy of the target-related tissue ancestry-correlated binding agent, relative to additional effects of the use of the target-related tissue ancestry-correlated binding agent (e.g., relative to a degree of discrimination provided by the target-related tissue ancestry-correlated binding agent(s)).

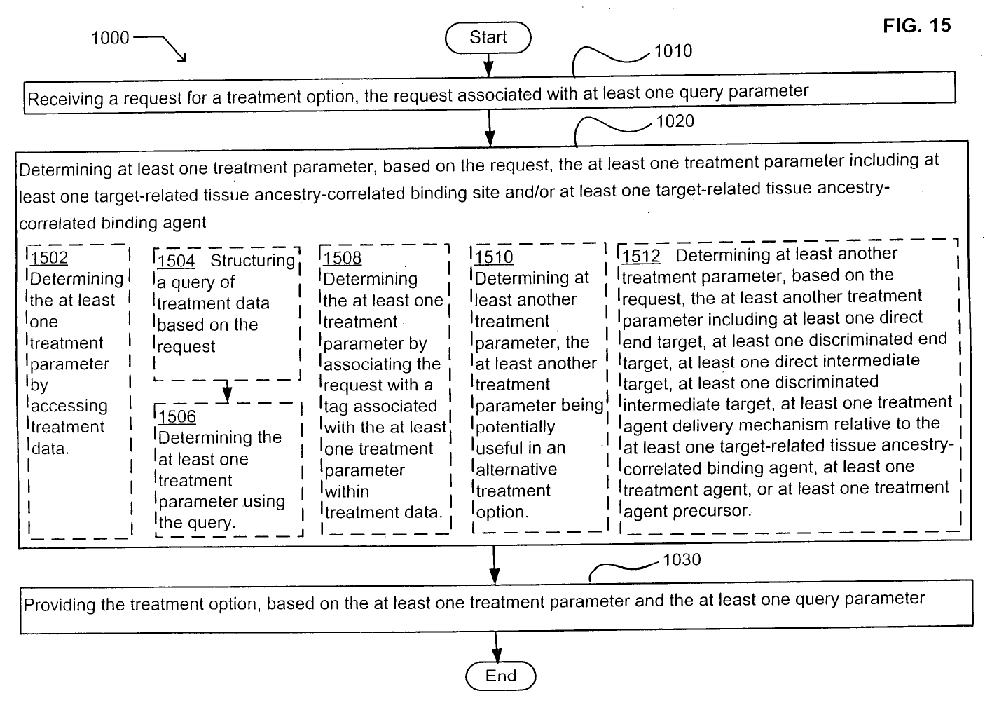

FIG. 15 illustrates alternative embodiments of the example operational flow 1000 of FIG. 10. FIG. 15 illustrates example embodiments where the determining operation 1020 may include at least one additional operation. Additional operations may include an operation 1502, an operation 1504, an operation 1506, an operation 1508, an operation 1510, and/or an operation 1512.

At the operation 1502, the at least one treatment parameter may be determined by accessing treatment data. For example, the search logic 908 may determine the at least one treatment parameter by accessing the treatment data 126, e.g., based on the request as received from the user interface 132.

At the operation 1504 a query of treatment data may be structured based on the request. For example, the search logic 908 may structure a query of the treatment data 126, e.g., in conjunction with the query generator 914 of the DBMS engine 130. Then, at the operation 1506, the at least one treatment parameter may be determined using the query. Continuing the example just given, then, the search logic 908 may determine the treatment parameter based on the results returned from the treatment data 126 in response to the query.

At the operation 1508, the at least one treatment parameter may be determined by associating the request with a tag associated with the at least one treatment parameter within treatment data. For example, user interface 132 may be used to submit a request for a treatment option associated with a target-related tissue ancestry-correlated binding site that has a high degree of discrimination between a direct end target and a discriminated end target. Such a target-related tissue ancestry-correlated binding site(s) maybe identified within the treatment data 126 using the tag(s) 918, 920, so that the search logic 908 may determine examples of the target-related tissue ancestry-correlated binding site(s) having the desired characteristics.

At the operation 1510, at least another treatment parameter may be determined, the at least another treatment parameter being potentially useful in an alternative treatment option. For example, the search logic 908 may determine a plurality of treatment parameters, e.g., may determine a plurality of instances of a particular target-related tissue ancestry-correlated binding site, where each instance may be considered to provide a possible or alternative treatment option. By determining a plurality of treatment parameters useful in one or more treatment options, the treatment system 102 allows the clinician 104 to select an optimal treatment option from among the available possibilities.

At the operation 1512 at least another treatment parameter may be determined, based on the request, the at least another treatment parameter including at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor. For example, the request may be associated with one or more query parameters, and a direct intermediate target may be determined, based on the request, in conjunction with the target-related tissue ancestry-correlated binding site and/or the target-related tissue ancestry-correlated binding agent.

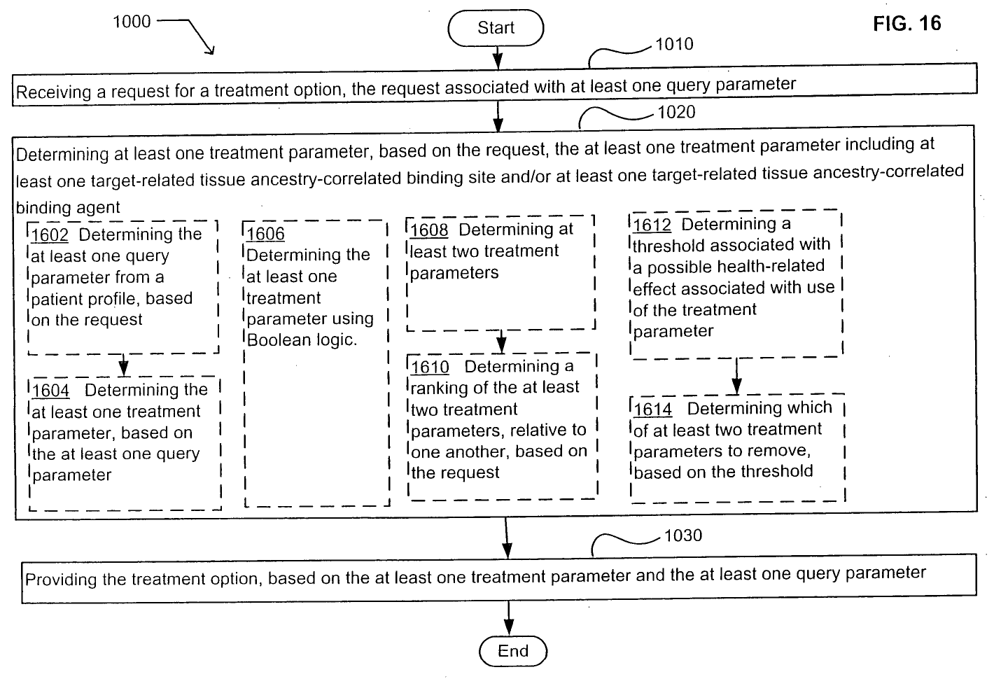

FIG. 16 illustrates alternative embodiments of the example operational flow 1000 of FIG. 10. FIG. 16 illustrates example embodiments where the determining operation 1020 may include at least one additional operation. Additional operations may include an operation 1602, an operation 1604, an operation 1606, an operation 1608, an operation 1610, an operation 1612, and/or an operation 1614.

At the operation 1602, the at least one query parameter may be determined from a patient profile, based on the request. For example, the clinician 104 may submit the request, and the search logic 908 may automatically associate the request with a query parameter from the patient profile 922. For example, the request may be for a treatment option associated with delivering the treatment agent “radionuclides” to the direct end target “cancer cells in lung.” In this case, the patient profile 922 for the patient 106 may identify some characteristic of the patient 106 that may be pertinent to the request, such as, for example, that the patient 106 has a weakened liver. Then, the search logic may automatically include the query parameter “weakened liver” and/or “minimize delivery of treatment agent to liver.” Then, at the operation 1604, the at least one treatment parameter may be determined, based on the at least one query parameter. For example, the treatment parameter may be determined as one that has a high level of discrimination between “cancer cells in lung” and “liver (tissue).”

At the operation 1606, the at least one treatment parameter may be determined using Boolean logic. For example, the search logic 908 may formulate a query of the treatment data 126 in which the at least one query parameter includes a Boolean operator (e.g., AND, OR, NOT, or XOR), and/or in which the at least one query parameter includes one or more operands of a Boolean operation. Accordingly, the at least one treatment parameter may be determined with a high degree of specificity, and may be associated with particularized or customized uses (e.g., treatment options).

At the operation 1608, at least two treatment parameters may be determined. For example, the search logic 908 may determine a plurality of treatment parameters, such as, for example, a plurality of instances of the at least one target-related tissue ancestry-correlated binding site, where each of the plurality satisfy the request and/or the at least one query parameter. Then, at the operation 1610, a ranking of the at least two treatment parameters, relative to one another, may be determined based on the request. For example, as described herein, the request (e.g., the query parameter, when the query parameter is included in the request) may specify a ranking criteria, such as, for example, a degree of discrimination, or level of efficacy of use of the treatment parameter.

At the operation 1612, a threshold associated with a possible health-related effect associated with use of the treatment parameter may be determined. For example, as just mentioned, the treatment parameter may be associated with a health-related effect, such as, for example, a certain degree of discrimination, or a certain level of efficacy of use of the treatment parameter. Accordingly, in such examples, a threshold discrimination or efficacy may be determined. Then, at the operation 1614, which of at least two treatment parameters to remove may be determined, based on the threshold. For example, at least one of the at least two treatment parameters may be removed that is below (or above) the specified threshold. In this way, only the most relevant or useful treatment parameter(s) may be determined.

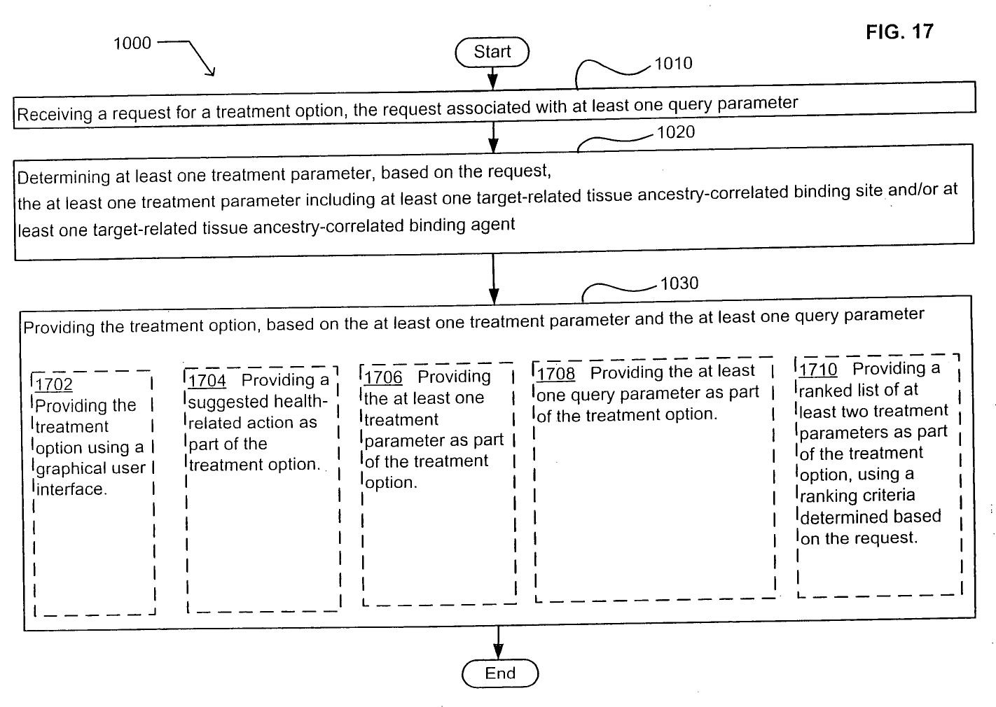

FIG. 17 illustrates alternative embodiments of the example operational flow 1000 of FIG. 10. FIG. 17 illustrates example embodiments where the providing operation 1030 may include at least one additional operation. Additional operations may include an operation 1702, an operation 1704, an operation 1706, an operation 1708, and/or an operation 1710.

At the operation 1702, the treatment option may be provided using a graphical user interface. For example, the treatment option logic 910 may provide the treatment option using the field 816 of the user interface 132, or, more generally, may use the display element 904 of the user interface 132.

At the operation 1704, a suggested health-related action may be provided as part of the treatment option. For example, the treatment option logic 910 may suggest an action such as application of the treatment agent (which may include radionuclides or other treatment agent(s)) of the field 804 intravenously, or in pill form, and/or with a certain frequency or dosage.

At the operation 1706, the at least one treatment parameter may be provided as part of the treatment option. For example, the treatment option logic 910 may provide one or more instances of the target-related tissue ancestry-correlated binding agent, as part of a treatment option provided to the clinician 104 for delivering the treatment agent of the field 804.

At the operation 1708, the at least one query parameter may be provided as part of the treatment option. For example, the at least one query parameter may include a body portion to which the treatment agent may be delivered (or to which the treatment agent should not be delivered). In such examples, then, the treatment option logic 910 may include the body portion with the provided treatment option. In other examples, the query parameter may include a desired effect of the treatment agent, and the treatment option logic 910 may include a description of the desired effect in association with the provided treatment option.

At the operation 1710, a ranked list of at least two treatment parameters may be provided as part of the treatment option, using a ranking criteria determined based on the request. For example, as described herein, the clinician 104 may indicate in the request that treatment options should be provided according to a ranking criteria, and based, e.g., on a degree of discrimination provided by the treatment options, or based on a priority of one potential/desired effect (e.g., a priority of maximizing elimination of the treatment agent by the patient 106).

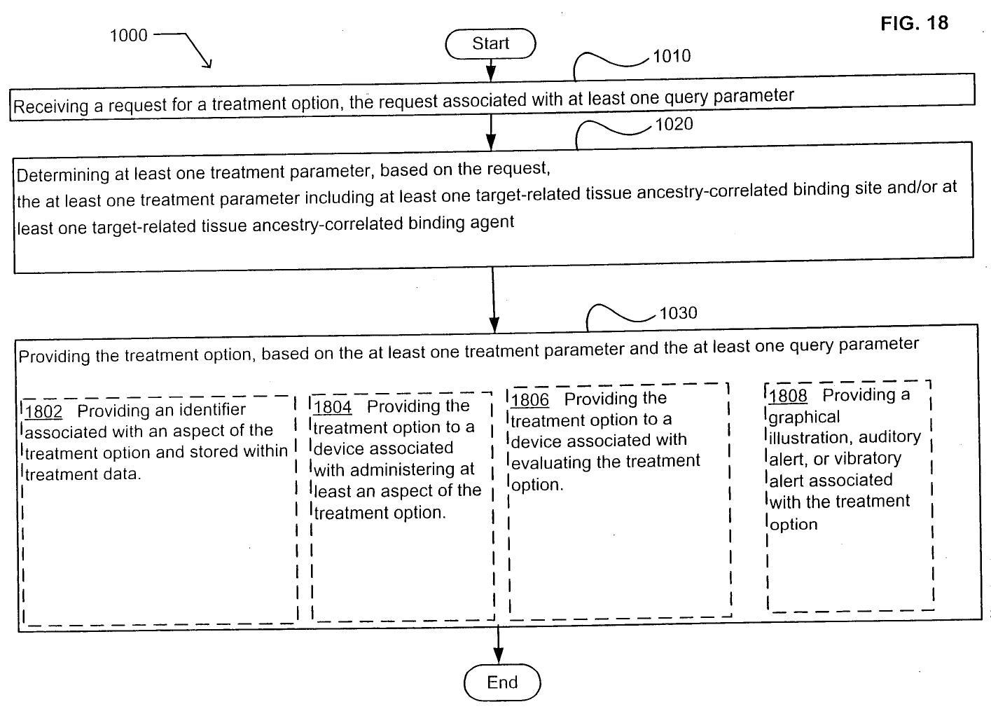

FIG. 18 illustrates alternative embodiments of the example operational flow 1000 of FIG. 10. FIG. 18 illustrates example embodiments where the providing operation 1030 may include at least one additional operation. Additional operations may include an operation 1802, an operation 1804, an operation 1806, and/or an operation 1808.

At the operation 1802, an identifier associated with an aspect of the treatment option may be provided and stored within treatment data. For example, it may be the case that the search logic 908 provides or requires extensive computation or calculation in determining results, e.g., the at least one treatment parameter and/or in providing the treatment option(s). Accordingly, such computational effort may be saved in following operations, by associating an identifier with an aspect of the treatment option and storing the identifier within the treatment data 126.

At the operation 1804, the treatment option may be provided to a device associated with administering at least an aspect of the treatment option. For example, the treatment option may include a certain dosage of the treatment agent, perhaps in response to a measurement of a condition of the patient 106. Thus, a device may be used to monitor a condition of the patient 106 (e.g., monitor a blood pressure, temperature, or blood oxygen level of the patient 106), and the treatment option may be provided in response to the monitoring, by the device or by a related device.

At the operation 1806, the treatment option may be provided to a device associated with evaluating the treatment option. For example, the treatment option logic 910 may provide a plurality of treatment options to a device, e.g., the clinician device 134. The device may thus, for example, evaluate the treatment option(s) from a clinical perspective, e.g., relative to the original request and/or query parameter, in order to provide the clinician 104 with additional information. In other implementations, the device may evaluate the treatment option(s) with respect to other criteria, such as, for example, a cost of the treatment option.

At the operation 1808, a graphical illustration, auditory alert, or vibratory alert associated with the treatment option may be provided. For example, the treatment option logic 910 may generate a graphical illustration of the patient 106, and may illustrate or otherwise provide effects (both desired and undesired) of the treatment option(s) using the graphical illustration (e.g., by highlighting or otherwise visually emphasizing a body portion that is affected by the treatment option). In other examples, the clinical device 134 may provide an auditory or vibratory alert in order, for example, to notify the clinician 104 that a current need exists for the treatment option.

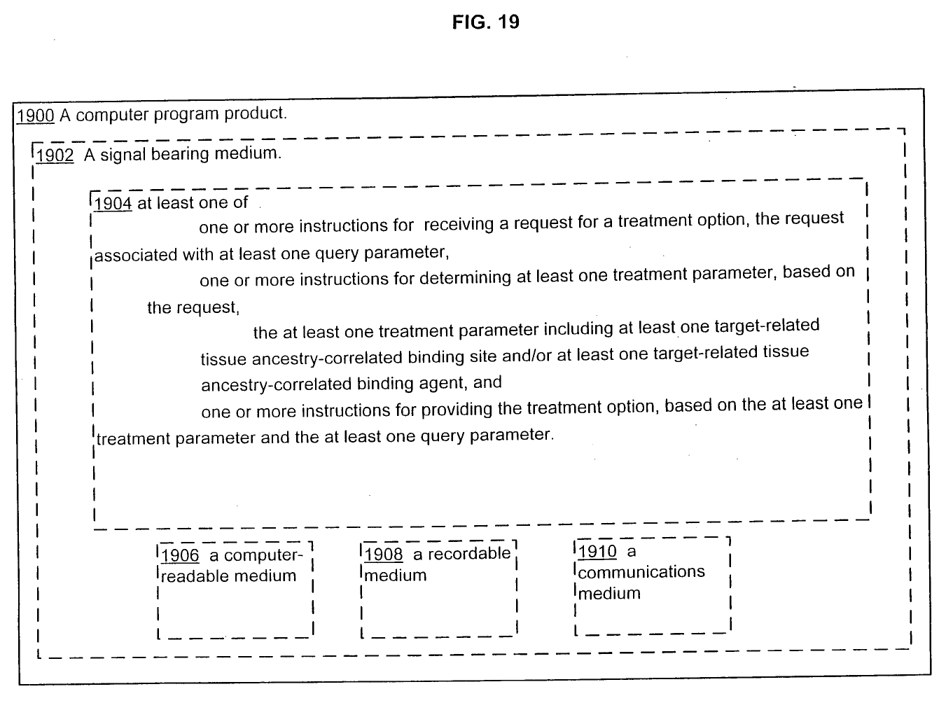

FIG. 19 illustrates a partial view of an example computer program product 1900 that includes a computer program 1904 for executing a computer process on a computing device. An embodiment of the example computer program product 1900 is provided using a signal bearing medium 1902, and may include at least one of one or more instructions for receiving a request for a treatment option, the request associated with at least one query parameter, the signal bearing medium also bearing one or more instructions for determining at least one treatment parameter, based on the request, the at least one treatment parameter including at least one target-related tissue ancestry-correlated binding site and/or at least one target-related tissue ancestry-correlated binding agent, the signal bearing medium also bearing one or more instructions for providing the treatment option, based on the at least one treatment parameter and the at least one query parameter. The one or more instructions may be, for example, computer executable and/or logic-implemented instructions. In one implementation, the signal-bearing medium 1902 may include a computer-readable medium 1906. In one implementation, the signal bearing medium 1902 may include a recordable medium 1908. In one implementation, the signal bearing medium 1902 may include a communications medium 1910.

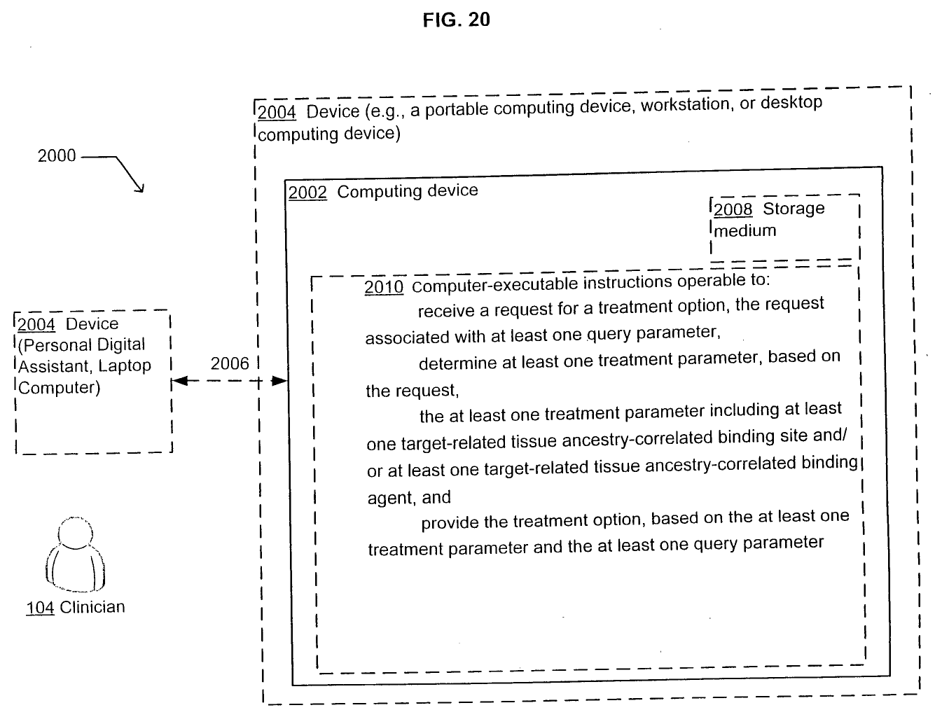

FIG. 20 illustrates an example system 2000 in which embodiments may be implemented. The system 2000 includes a computing system environment. The system 2000 also illustrates the clinician 104 using a device 2004, which is optionally shown as being in communication with a computing device 2002 by way of an optional coupling 2006. The optional coupling 2006 may represent a local, wide-area, or peer-to-peer network, or may represent a bus that is internal to a computing device (e.g., in example embodiments in which the computing device 2002 is contained in whole or in part within the device 2004). A storage medium 2008 may be any computer storage media.

The computing device 2002 includes computer-executable instructions 2010 that when executed on the computing device 2002 cause the computing device 2002 to receive a request for a treatment option, the request associated with at least one query parameter, determine at least one treatment parameter, based on the request, the at least one treatment parameter including at least one target-related tissue ancestry-correlated binding site and/or at least one target-related tissue ancestry-correlated binding agent, and provide the treatment option, based on the at least one treatment parameter and the at least one query parameter.

In FIG. 20, then, the system 2000 includes at least one computing device (e.g., 2002 and/or 2004). The computer-executable instructions 2010 may be executed on one or more of the at least one computing device. For example, the computing device 2002 may implement the computer-executable instructions 2010 and output a result to (and/or receive data from) the computing (clinician) device 2004. Since the computing device 2002 may be wholly or partially contained within the computing (clinician) device 2004, the computing (clinician) device 2004 also may be said to execute some or all of the computer-executable instructions 2010, in order to be caused to perform or implement, for example, various ones of the techniques described herein, or other techniques.

The clinician device 2004 may include, for example, one or more of a personal digital assistant (PDA), a laptop computer, a tablet personal computer, a networked computer, a computing system comprised of a cluster of processors, a workstation computer, and/or a desktop computer. In another example embodiment, the. clinician device 2004 may be operable to communicate with the computing device 2002 to communicate with a database (e.g., implemented using the storage medium 2008) to access the at least one treatment parameter(s).

In addition to references described above, the following are also hereby incorporated by reference in their entireties to the extent such are not inconsistent herewith:

Pasqualini et al., “Probing the Structural and Molecular Diversity of Tumor Vasculature,” TRENDS in Molecular Medicine, vol. 8, No. 12, pp. 563-571 (December 2002);

Aird et al., “Vascular Bed-specific Expression of an Endothelial Cell Gene is Programmed by the Tissue Microenvironment,” The Journal of Cell Biology, vol. 138, No. 5, pp. 1117-1124 (Sep. 8, 1997);

Pasqualini et al., “Organ Targeting In Vivo Using Phage Display Peptide Libraries,” Nature, vol. 380, pp. 364-366 (Mar. 28, 1996);

Rajotte et al., “Molecular Heterogeneity of the Vascular Endothelium Revealed by In Vivo Phage Display,” J. Clin. Invest., vol. 102, No. 2, pp. 430-437 (July 1998);

M'Rini, et al., “A Novel Endothelial L-Selectin Ligand Activity in Lymph Node Medulla That Is Regulated by (1,3)-Fucosyltransferase-IV,” J. Exp. Med., vol. 198, No. 9, pp. 1301-1312 (Nov. 3, 2003);

Carver, et al., “Caveolae: Mining Little Caves for New Cancer Targets,” Nature Reviews, vol. 3, pp. 571-572 (August 2003);

Folkman, Judah, “Looking For A Good Endothelial Address,” Cancer Cell, pp. 113-115 (March 2002);

Brody, Lawrence C., “Treating Cancer by Targeting a Weakness,” N Engl J Med, 353; 9 pp. 949-950 (1 Sep. 2005);

Farmer, et al., “Targeting the DNA Repair Defect in BRCA Mutant Cells as a Therapeutic Strategy,” Nature, vol. 434, pp. 917-921 (14 Apr. 2005);

Bryant, et al., “Specific Killing of BRCA2-Deficient Tumours with Inhibitors of poly(ADP-ribose) Polymerase,” Nature, vol. 434, pp. 913-917 (14 Apr. 2005);

Hsu, et al., “Neural Systems Responding to Degrees of Uncertainty in Human Decision-Making,” Science, vol. 310, pp. 1680-1683 (9 Dec. 2005);

Kaplan, et al., “VEGFR1 -Postive Haematopoietic Bone Marrow Progenitors Initiate The Pre-Metastatic Niche,” Nature, vol. 438, pp. 820-825 (8 Dec. 2005).

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed is:

1. A system comprising:
means for receiving a request for a treatment option, the request associated with at least one query parameter;
means for determining at least one treatment parameter, based on the request,
the at least one treatment parameter including at least one target-related tissue ancestry-correlated binding site and/or at least one target-related tissue ancestry-correlated binding agent; and
means for providing the treatment option, based on the at least one treatment parameter and the at least one query parameter.

2. The system of claim 1 wherein the means for receiving a request for a treatment option, the request associated with at least one query parameter, comprises:
means for receiving the request from a user interface.

3. The system of claim 1 wherein the means for receiving a request for a treatment option, the request associated with at least one query parameter, comprises:
means for receiving the request from a device associated with the query parameter.

4. The system of claim 1 wherein the means for receiving a request for a treatment option, the request associated with at least one query parameter, comprises:
means for receiving the request from treatment data in which the query parameter is stored.

5. The system of claim 1 wherein the means for receiving a request for a treatment option, the request associated with at least one query parameter, comprises:
means for receiving the request, the at least one query parameter associated with a body portion potentially associated with the treatment option.

6. The system of claim 1 wherein the means for receiving a request for a treatment option, the request associated with at least one query parameter, comprises:
means for receiving the request, the query parameter associated with a systemic consequence potentially associated with the treatment option.

7. The system of claim 1 wherein the means for receiving a request for a treatment option, the request associated with at least one query parameter, comprises:
means for receiving the request, the query parameter associated with a body portion identified in the request as being more affected by the treatment option, relative to at least one other treatment option.

8. The system of claim 1 wherein the means for receiving a request for a treatment option, the request associated with at least one query parameter, comprises:
means for receiving the request, the query parameter associated with a body portion identified in the request as being less affected by the treatment option, relative to at least one other treatment option.

9. The system of claim 1 wherein the means for receiving a request for a treatment option, the request associated with at least one query parameter, comprises:
means for receiving the request, the at least one query parameter associated with a potential health-related effect associated with the treatment option.

10. The system of claim 1 wherein the means for receiving a request for a treatment option, the request associated with at least one query parameter, comprises:
means for receiving the request, the at least one query parameter associated with a degree of a potential health-related effect of the treatment option.

11. The system of claim 1 wherein the means for receiving a request for a treatment option, the request associated with at least one query parameter, comprises:
means for receiving the request, the at least one query parameter associated with a priority of a potential health-related effect of the treatment option, relative to at least another potential health-related effect.

12. The system of claim 1 wherein the means for receiving a request for a treatment option, the request associated with at least one query parameter, comprises:
means for receiving the request, the at least one query parameter associated with a health-related action associated with the treatment option.

13. The system of claim 1 wherein the means for receiving a request for a treatment option, the request associated with at least one query parameter, comprises:
means for receiving the request, the at least one query parameter including a Boolean operator.

14. The system of claim 1 wherein the means for receiving a request for a treatment option, the request associated with at least one query parameter, comprises:
means for receiving the request, the request including the at least one treatment parameter.

15. The system of claim 1 wherein the means for receiving a request for a treatment option, the request associated with at least one query parameter, comprises:
means for receiving the request, the at least one query parameter associated with a degree of discrimination between a direct end target and a discriminated end target.

16. The system of claim 1 wherein the means for receiving a request for a treatment option, the request associated with at least one query parameter, comprises:
means for receiving the request, the at least one query parameter associated with a degree of discrimination between a direct intermediate target and a discriminated intermediate target.

17. The system of claim 1 wherein the means for receiving a request for a treatment option, the request associated with at least one query parameter, comprises:
means for receiving the request, the at least one query parameter associated with an efficacy of the at least one target-related tissue ancestry-correlated binding site in delivering a treatment agent associated with the request to at least one body portion.

18. The system of claim 1 wherein the means for receiving a request for a treatment option, the request associated with at least one query parameter, comprises:
means for receiving the request, the at least one query parameter associated with an efficacy of the at least one target-related tissue ancestry-correlated binding agent in delivering a treatment agent associated with the request to at least one body portion.

19. The system of claim 1 wherein the means for determining at least one treatment parameter, based on the request, the at least one treatment parameter including at least one target-related tissue ancestry-correlated binding site and/or at least one target-related tissue ancestry-correlated binding agent, comprises:
means for determining the at least one treatment parameter by accessing treatment data.

20. The system of claim 1 wherein the means for determining at least one treatment parameter, based on the request, the at least one treatment parameter including at least one target-related tissue ancestry-correlated binding site and/or at least one target-related tissue ancestry-correlated binding agent, comprises:
means for structuring a query of treatment data based on the request; and
means for determining the at least one treatment parameter using the query.

21. The system of claim 1 wherein the means for determining at least one treatment parameter, based on the request, the at least one treatment parameter including at least one target-related tissue ancestry-correlated binding site and/or at least one target-related tissue ancestry-correlated binding agent, comprises:
means for determining the at least one treatment parameter by associating the request with a tag associated with the at least one treatment parameter within treatment data.

22. The system of claim 1 wherein the means for determining at least one treatment parameter, based on the request, the at least one treatment parameter including at least one target-related tissue ancestry-correlated binding site and/or at least one target-related tissue ancestry-correlated binding agent, comprises:
means for determining at least another treatment parameter, the at least another treatment parameter being potentially useful in an alternative treatment option.

23. The system of claim 1 wherein the means for determining at least one treatment parameter, based on the request, the at least one treatment parameter including at least one target-related tissue ancestry-correlated binding site and/or at least one target-related tissue ancestry-correlated binding agent, comprises:
means for determining at least another treatment parameter, based on the request, the at least another treatment parameter including at least one direct end target, at least one discriminated end target, at least one direct intermediate target, at least one discriminated intermediate target, at least one treatment agent delivery mechanism relative to the at least one target-related tissue ancestry-correlated binding agent, at least one treatment agent, or at least one treatment agent precursor.

24. The system of claim 1 wherein the means for determining at least one treatment parameter, based on the request, the at least one treatment parameter including at least one target-related tissue ancestry-correlated binding site and/or at least one target-related tissue ancestry-correlated binding agent, comprises:
means for determining the at least one query parameter from a patient profile, based on the request; and
means for determining the at least one treatment parameter, based on the at least one query parameter.

25. The system of claim 1 wherein the means for determining at least one treatment parameter, based on the request, the at least one treatment parameter including at least one target-related tissue ancestry-correlated binding site and/or at least one target-related tissue ancestry-correlated binding agent, comprises:
means for determining the at least one treatment parameter using Boolean logic.

26. The system of claim 1 wherein the means for determining at least one treatment parameter, based on the request, the at least one treatment parameter including at least one target-related tissue ancestry-correlated binding site and/or at least one target-related tissue ancestry-correlated binding agent, comprises:
means for determining at least two treatment parameters; and
means for determining a ranking of the at least two treatment parameters, relative to one another, based on the request.

27. The system of claim 1 wherein the means for determining at least one treatment parameter, based on the request, the at least one treatment parameter including at least one target-related tissue ancestry-correlated binding site or at least one target-related tissue ancestry-correlated binding agent, comprises:
means for determining a threshold associated with a possible health-related effect associated with use of the treatment parameter; and
means for determining which of at least two treatment parameters to remove, based on the threshold.

28. The system of claim 1 wherein the means for providing the treatment option, based on the at least one treatment parameter and the at least one query parameter, comprises:
means for providing the treatment option using a graphical user interface.

29. The system of claim 1 wherein the means for providing the treatment option, based on the at least one treatment parameter and the at least one query parameter, comprises:
means for providing a suggested health-related action as part of the treatment option.

30. The system of claim 1 wherein the means for providing the treatment option, based on the at least one treatment parameter and the at least one query parameter, comprises:
means for providing the at least one treatment parameter as part of the treatment option.

31. The system of claim 1 wherein the means for providing the treatment option, based on the at least one treatment parameter and the at least one query parameter, comprises:
means for providing the at least one query parameter as part of the treatment option.

32. The system of claim 1 wherein the means for providing the treatment option, based on the at least one treatment parameter and the at least one query parameter, comprises:
means for providing a ranked list of at least two treatment parameters as part of the treatment option, using a ranking criteria determined based on the request.

33. The system of claim 1 wherein the means for providing the treatment option, based on the at least one treatment parameter and the at least one query parameter, comprises:
means for providing an identifier associated with an aspect of the treatment option and stored within treatment data.

34. The system of claim 1 wherein the means for providing the treatment option, based on the at least one treatment parameter and the at least one query parameter, comprises:
means for providing the treatment option to a device associated with administering at least an aspect of the treatment option.

35. The system of claim 1 wherein the means for providing the treatment option, based on the at least one treatment parameter and the at least one query parameter, comprises:
means for providing the treatment option to a device associated with evaluating the treatment option.

36. The system of claim 1 wherein the means for providing the treatment option, based on the at least one treatment parameter and the at least one query parameter, comprises:
means for providing a graphical illustration, auditory alert, or vibratory alert associated with the treatment option.

37-47. (canceled)

48. A computer program product comprising:
A signal-bearing medium bearing
(a) one or more instructions for receiving a request for a treatment option, the request associated with at least one query parameter;
(b) one or more instructions for determining at least one treatment parameter by accessing treatment data, based on the request,
the at least one treatment parameter including at least one target-related tissue ancestry-correlated binding site and/or at least one target-related tissue ancestry-correlated binding agent; and
(c) one or more instructions for providing the treatment option, based on the at least one treatment parameter and the at least one query parameter.

49. A computer program product comprising:
A signal-bearing medium bearing
(a) one or more instructions for receiving a request for a treatment option, the request associated with at least one query parameter;
(b) one or more instructions for determining at least one treatment parameter, based on the request,
the at least one treatment parameter including at least one target-related tissue ancestry-correlated binding site and/or at least one target-related tissue ancestry-correlated binding agent; and
(c) one or more instructions for providing the treatment option, based on the at least one treatment parameter and the at least one query parameter,
the treatment option containing a ranked list of at least two treatment parameters that are ranked using a ranking criteria determined based on the request.
